(19) United States
(12) Patent Application Publication
(10) Pub. No.: US 2026/0141863 A1
(43) Pub. Date: May 21, 2026

(54) DISPLAY PANEL, DISPLAY DEVICE AND GATE DRIVING CIRCUIT

(71) Applicant: LG Display Co., Ltd., Seoul (KR)

(72) Inventors: Min June JANG, Paju-si (KR); Mi Young SON, Paju-si (KR)

(73) Assignee: LG Display Co., Ltd., Seoul (KR)

(21) Appl. No.: 19/344,169

(22) Filed: Sep. 29, 2025

(30) Foreign Application Priority Data
Nov. 15, 2024 (KR) 10-2024-0163011

(51) Int. Cl. G09G 3/3266; G09G 3/32; G09G 3/3275

(52) U.S. Cl. CPC G09G 3/3266; G09G 3/32; G09G 3/3275; G09G 2300/0426; G09G 2310/0267; G09G 2310/0275; G09G 2310/08

(57) ABSTRACT

Discussed are a display panel, a display device and a gate driving circuit. The display panel can include a gate driving circuit including transistors positioned between sub-pixel circuits, first-direction wires positioned in parallel along a first direction, and second-direction wires positioned in parallel along a second direction intersecting the first direction. The gate driving circuit includes a plurality of odd-numbered stages and a plurality of even-numbered stages. Each of the odd-numbered stages and the even-numbered stages includes a transistor A, a transistor B, and a transistor C. The transistor A, the transistor B, and the transistor C of the odd-numbered stages are arranged in an order from one side to another side in the first direction. The transistor C, the transistor B, and the transistor A of the even-numbered stages are arranged in an order from the one side to the another side in the first direction.

### CROSS-REFERENCE TO RELATED APPLICATION

This application claims priority to Korean Patent Application No. 10-2024-0163011, filed in the Republic of Korea on Nov. 15, 2024, the disclosure of which is incorporated by reference in its entirety.

### BACKGROUND

### Technical Field

The present disclosure relates to a display panel, more particularly, for example, without limitation, to a display panel and a display device including the same, as well as a gate driving circuit in the same.

### Discussion of the Related Art

A display device is applied to various electronic devices such as a television, a mobile phone, a laptop, and a tablet. The display device includes an organic light emitting display device (OLED) that emits light by itself, and a liquid crystal display device (LCD) that requires a separate light source.

Recently, a display device including a light emitting diode (LED) has gained attention as a next-generation display device. Since the light emitting diode is formed of an inorganic material rather than an organic material, it provides faster lighting speed, superior luminous efficiency, and the capability to display high-luminance images, compared to the liquid crystal display device or the organic light emitting display device.

The display device can include a plurality of sub-pixels arranged in a panel, and various circuits for driving the plurality of sub-pixels. For example, the display device can include a gate driving circuit that controls the driving timing of the plurality of sub-pixels, and a data driving circuit that supplies data voltages corresponding to image data to the plurality of sub-pixels.

The gate driving circuit can be configured with a plurality of switches and wires for supplying gate pulses to a plurality of gate lines. The gate driving circuit can be directly formed on the same substrate together with the sub-pixels of the display panel.

### SUMMARY OF THE DISCLOSURE

The inventors have realized that when the gate driving circuit is formed together with the sub-pixels, compared to a case where the gate driving circuit is positioned in a bezel region of the display device, there can be a great number of wires that need to be added and/or formed. As the types of such wires become more diverse and complicated, the wire length can increase, which can cause a degradation in the output characteristics of the gate driving circuit. Accordingly, an object of the present disclosure is to solve or address the above-described necessity and/or limitations associated with the related art, to reduce wire lengths and improve output characteristics of the gate driving circuit.

The objectives of the present disclosure are not limited to those mentioned above, and other objectives not explicitly mentioned will be clearly understood by those skilled in the art from the following description.

A display panel according to an example embodiment of the present disclosure includes sub-pixel circuits; a gate driving circuit including transistors positioned between the sub-pixel circuits; first-direction wires positioned in parallel along a first direction; and second-direction wires positioned in parallel along a second direction intersecting the first direction. The gate driving circuit includes a plurality of odd-numbered stages; and a plurality of even-numbered stages. Each of the odd-numbered stages and the even-numbered stages includes a transistor A, a transistor B, and a transistor C. The transistor A, the transistor B, and the transistor C of the odd-numbered stages are arranged in an order from one side to the other side in the first direction. The transistor C, the transistor B, and the transistor A of the even-numbered stages are arranged in an order from one side to the other side in the first direction.

According to aspects of the present disclosure, a first clock signal can be applied to the transistor A and the transistor B of the odd-numbered stages. A second clock signal can be applied to the transistor C of the odd-numbered stages. The second clock signal can be applied to the transistor A and the transistor B of the even-numbered stages. The first clock signal can be applied to the transistor C of the even-numbered stages.

According to aspects of the present disclosure, the second-direction wires can include: a first clock signal wire connected to the transistor A of the odd-numbered stages and to the transistor C of the even-numbered stages; a second clock signal wire connected to the transistor B of the odd-numbered stages; a third clock signal wire connected to the transistor B of the even-numbered stages; and a fourth clock signal wire connected to the transistor C of the odd-numbered stages and to the transistor A of the even-numbered stages.

According to aspects of the present disclosure, the lengths of the first clock signal wire, the second clock signal wire, the third clock signal wire, and the fourth clock signal wire can be equal to each other.

According to aspects of the present disclosure, each of the odd-numbered stages can further include a transistor D positioned between the transistor B and the transistor C of the odd-numbered stage in the first direction. Each of the even-numbered stages can further include a transistor D positioned between the transistor B and the transistor C of the even-numbered stage in the first direction.

According to aspects of the present disclosure, when viewed in the second direction, the transistor A of the odd-numbered stages can be positioned adjacent to the transistor C of the even-numbered stages. When viewed in the second direction, the transistor B of a (2K−1)th stage (where K is a natural number) can be positioned adjacent to the transistor B of a (2K+1)th stage, with the transistor D of a (2K)th stage interposed therebetween. When viewed in the second direction, the transistor C of the odd-numbered stages can be positioned adjacent to the transistor A of the even-numbered stages. When viewed in the second direction, the transistor D of the (2K−1)th stage can be positioned adjacent to the transistor D of the (2K+1)th stage, with the transistor B of the (2K)th stage interposed therebetween.

According to aspects of the present disclosure, the transistor A of the odd-numbered stages can include a first electrode connected to a Q node of a corresponding odd-numbered transistor, a gate electrode to which the first clock signal is applied, and a second electrode connected to a start signal input node. The transistor A of the even-numbered stages can include a first electrode connected to a Q node of a corresponding even-numbered transistor, a gate electrode to which the second clock signal is applied, and a second electrode connected to a start signal input node.

According to aspects of the present disclosure, the transistor B of the odd-numbered stages can include a first electrode, a gate electrode to which the first clock signal is applied, and a second electrode. The transistor B of the even-numbered stages can include a first electrode, a gate electrode to which the second clock signal is applied, and a second electrode.

According to aspects of the present disclosure, the transistor C of the odd-numbered stages can include a first electrode, a gate electrode connected to a start signal input node, and a second electrode to which the second clock signal is applied. The transistor C of the even-numbered stages can include a first electrode, a gate electrode connected to a start signal input node, and a second electrode to which the first clock signal is applied.

According to aspects of the present disclosure, the gate driving circuit can include a light emitting driving circuit configured to supply an emission signal to the sub-pixel circuits.

According to aspects of the present disclosure, the transistor C can include a first electrode connected to a pump capacitor, a gate electrode connected to a start signal input node, and a second electrode connected to a clock node to which a clock signal is applied.

According to aspects of the present disclosure, the transistor C can operate in response to a voltage level of the start signal input node to which a forward start signal or a reverse start signal is inputted.

According to aspects of the present disclosure, the clock signal can include a first clock signal and a second clock signal different from each other.

According to aspects of the present disclosure, the first clock signal can be a signal in which a first level and a second level alternate, and the second clock signal can be a signal in which the second level and the first level alternate.

A display device according to an example embodiment of the present disclosure includes a display panel including sub-pixel circuits, a gate driving circuit including transistors positioned between the sub-pixel circuits, first-direction wires positioned in parallel along a first direction, and second-direction wires positioned in parallel along a second direction intersecting the first direction; and a source circuit electrically connected to a pad region of the display panel and configured to supply a data signal and a clock signal to the display panel. The gate driving circuit includes a plurality of odd-numbered stages, and a plurality of even-numbered stages. Each of the odd-numbered stages and the even-numbered stages includes a transistor A, a transistor B, and a transistor C. The transistor A, the transistor B, and the transistor C of the odd-numbered stages are arranged in an order from one side to the other side in the first direction. The transistor C, the transistor B, and the transistor A of the even-numbered stages are arranged in an order from one side to the other side in the first direction.

A gate driving circuit according to an example embodiment of the present disclosure includes a plurality of odd-numbered stages; and a plurality of even-numbered stages. Each of the odd-numbered stages and the even-numbered stages includes a transistor A, a transistor B, and a transistor C. The transistor A, the transistor B, and the transistor C of the odd-numbered stages are arranged in an order from one side to the other side in the first direction. The transistor C, the transistor B, and the transistor A of the even-numbered stages are arranged in an order from the one side to the other side in the first direction.

According to aspects of the present disclosure, balance in design structure can be achieved, so that wire lengths can be reduced and output characteristics of the gate driving circuit can be improved.

According to aspects of the present disclosure, the operational reliability of the display device can be enhanced and low-power driving can be achieved.

According to aspects of the present disclosure, the effective design area of a space within the display panel can be increased as portions that were extended to connect wires and transistors are removed.

The effects of the present disclosure are not limited to the aforementioned effects, and other effects, which are not mentioned above, will be apparently understood to a person having ordinary skill in the art from the following description.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a schematic configuration diagram of a display device according to one or more example embodiments of the present disclosure;

FIG. 2 is a schematic plan view of a display panel included in a display device according to one or more example embodiments of the present disclosure;

FIG. 3 is a plan view of a unit pixel region included in a display device according to one or more example embodiments of the present disclosure;

FIG. 4 is a circuit diagram of a sub-pixel included in a display device according to one example embodiment of the present disclosure;

FIG. 5 is a diagram illustrating an arrangement method of a gate driver in a display device according to one example embodiment of the present disclosure;

FIG. 6 is a diagram illustrating a configuration of a gate driver included in a display device according to one example embodiment of the present disclosure;

FIG. 7 is a diagram illustrating a light emitting driving circuit included in a gate driver according to an example embodiment of the present disclosure;

FIG. 8 is a diagram illustrating a driving timing of the light emitting driving circuit shown in FIG. 7;

FIG. 9 is a diagram illustrating a light emitting driving circuit included in a gate driver according to an example embodiment of the present disclosure;

FIG. 10 is a diagram illustrating a comparison of driving timings between an odd-numbered stage and an even-numbered stage according to an example embodiment of the present disclosure;

FIG. 11 is a schematic plan view illustrating an arrangement structure of a display device according to an example embodiment of the present disclosure;

FIG. 12 is a graph illustrating unstable signal output due to an increase in wire length;

FIG. 13 is a schematic plan view illustrating an arrangement structure of a display device according to an example embodiment of the present disclosure; and

FIG. 14 is a graph illustrating stable signal output resulting from an adjustment of wire length.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Reference will now be made in detail to embodiments of the present disclosure, examples of which can be illustrated in the accompanying drawings. The progression of processing steps and/or operations described is an example; however, the sequence of steps and/or operations is not limited to that set forth herein and can be changed as is known in the art, with the exception of steps and/or operations necessarily occurring in a particular order. Names of the respective elements used in the following explanations can be selected only for convenience of writing the specification and can be thus different from those used in actual products.

The advantages and features of the present disclosure and methods for accomplishing the same will be more clearly understood from embodiments described below with reference to the accompanying drawings. However, the present disclosure is not limited to the following embodiments but can be implemented in various different forms. Rather, the present embodiments will make the disclosure of the present disclosure complete and allow those skilled in the art to completely comprehend the scope of the present disclosure.

The shapes, sizes, dimensions (e.g., length, width, height, thickness, radius, diameter, area, etc.), ratios, angles, numbers of elements and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

Like reference numerals generally denote like elements throughout the present specification. Further, in describing the present disclosure, detailed descriptions of known related technologies can be omitted to avoid unnecessarily obscuring the subject matter of the present disclosure.

The terms such as “include,” “have,” “comprise,” “contain,” “constitute,” “make up of,” “formed of,” and “consist of” used herein are generally intended to allow other components to be added unless the terms are used with the term “only.” Any references to singular can include plural unless expressly stated otherwise.

Components are interpreted to include an ordinary error range even if not expressly stated.

When a positional or interconnected relationship is described between two components, such as “on”, “above”, “over”, “below”, “under”, “beside”, “beneath”, “near”, “close to,” “adjacent to”, “on a side of”, “next” or the like, one or more other components can be interposed between them, unless “immediately” or “directly” is used.

Spatially relative terms, such as “under,” “below,” “beneath”, “lower,” “over,” “upper” and the like, can be used herein for ease of description to describe one element or feature's relationship to another element(s) or feature(s) as illustrated in the drawings. It will be understood that the spatially relative terms can encompass different orientations of an element in use or operation in addition to the orientation depicted in the drawings. For example, if an element in the drawings is inverted, elements described as “below” or “beneath” other elements or features would then be oriented “over” the other elements or features. Thus, the example term “below” can encompass both an orientation of below and above. Similarly, the example term “above” or “over” can encompass both an orientation of “above” and “below”.

When a temporal antecedent relationship is described, such as “after”, “following”, “next to”, “before”, or the like, it may not be continuous on a time base unless “immediately” or “directly” is used.

The terms “first,” “second,” and the like can be used to distinguish elements from each other, but the functions or structures of the components are not limited by ordinal numbers or component names in front of the components.

The word “exemplary” is used to mean serving as an example or illustration. Aspects are example aspects. “Embodiments,” “examples,” “aspects,” and the like should not be construed as preferred or advantageous over other implementations. An embodiment, an example, an example embodiment, an aspect, or the like can refer to one or more embodiments, one or more examples, one or more example embodiments, one or more aspects, or the like, unless stated otherwise. Further, the term “can” encompasses all the meanings of the term “may” and vice versa.

The term “at least one” should be understood as including all possible combinations which can be suggested from one or more relevant items. For example, the meaning of “at least one of a first item, a second item, or a third item” can be each one of the first item, the second item, or the third item and also be all possible combinations that can be suggested from two or more of the first item, the second item, and the third item.

A term “device” used herein can refer to a display device including a display panel and a driver for driving the display panel. Examples of the display device can include a light emitting element, and the like. In addition, examples of the device can include a notebook computer, a television, a computer monitor, an automotive device, a wearable device, and an automotive equipment device, and a set electronic device (or apparatus) or a set device (or apparatus), for example, a mobile electronic device such as a smartphone or an electronic pad, which are complete products or final products respectively including light emitting element and the like, but embodiments of the present disclosure are not limited thereto.

The following embodiments can be partially or entirely bonded to or combined with each other and can be linked and operated in technically various ways. The embodiments can be carried out independently of or in association with each other.

Terms used in the embodiments of the present disclosure (including technical and scientific terms) are to be construed as they would be commonly understood by one of ordinary skill in the art to which the invention belongs, unless otherwise specifically defined and described, and commonly used terms, such as dictionary defined terms, are to be construed in light of their contextual meaning in the relevant art.

In the display device according to the present disclosure, the pixel circuit and the gate driving circuit can include a plurality of transistors. The transistors can be implemented as oxide thin film transistors (oxide TFTs) including an oxide semiconductor, low temperature polysilicon (LTPS) TFTs including low temperature polysilicon, as well as amorphous silicon TFTs including amorphous silicon (a-Si), or the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons can flow from a source to a drain. The n-channel transistor has a direction of a current flowing from the drain to the source. In the case of a p-channel transistor, since carriers are holes, a source voltage is higher than a drain voltage such that holes can flow from a source to a drain. In the p-channel transistor, since holes flow from the source to the drain, current flows from the source to the drain. It should be noted that a source and a drain of a transistor are not fixed. For example, a source and a drain can be changed according to an applied voltage. Therefore, the disclosure is not limited to a source and a drain of a transistor. In the following description, a source and a drain of a transistor will be referred to as a first electrode and a second electrode.

In the aspects of the present disclosure, a source electrode and a drain electrode are distinguished from each other, for convenience of description. However, the source electrode and the drain electrode are used interchangeably. The source electrode can be the drain electrode, and the drain electrode can be the source electrode. Further, the source electrode in any one aspect of the present disclosure can be the drain electrode in another aspect of the present disclosure, and the drain electrode in any one aspect of the present disclosure can be the source electrode in another aspect of the present disclosure.

A gate signal can swing between a gate-on voltage and a gate-off voltage. The transistor is turned on in response to the gate-on voltage and is turned off in response to the gate-off voltage. In the case of the n-channel transistor, the gate-on voltage can be a gate high voltage (or a high driving voltage), the gate-off voltage can be a gate low voltage VGL (or a low driving voltage). In case of the p-channel transistor, the gate-on voltage can be a gate low voltage VGL, and the gate-off voltage can be a gate high voltage VGH.

Further, in the examples of the present disclosure, the terms such as transistors A, B, C, D, etc. are used to refer to different transistors as discussed in the present specification, and may not represent the order or sequence of such transistors.

In the specification, in adding reference numerals for elements in each drawing, it should be noted that like reference numerals already used to denote like elements in other drawings are used for elements wherever possible. In addition, the dimension scales of constituent elements shown in the drawings can be different from actual dimension scales, for convenience of description. That is, the dimension scales of constituent elements shown in the drawings should not be interpreted to be the same as those shown in the drawings.

Hereinafter, example embodiments of the present disclosure will be described in detail with reference to the accompanying drawings. All the components of each display device/apparatus according to all embodiments of the present disclosure are operatively coupled and configured.

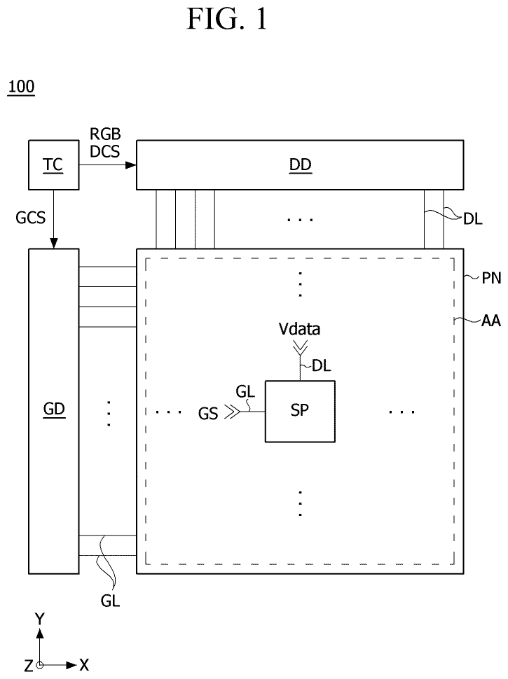

FIG. 1 is a schematic configuration diagram of a display device according to one example embodiment of the present disclosure.

Referring to FIG. 1, a display device 100 can include a display panel PN including a plurality of sub-pixels SP, a gate driver GD and a data driver DD, which supply various signals to the display panel PN, and a timing controller TC that controls the gate driver GD and the data driver DD.

The display panel PN includes a display area (or active area) AA in which an input image is visually reproduced. The display area AA can include a plurality of pixels and a gate driving circuit. Each of the pixels disposed in the display area AA of the display panel PN can include sub-pixels of different colors. In the display area AA, a plurality of gate wires GL and a plurality of data wires DL are crossed with each other, and each of a plurality of sub-pixels SP can be connected to the gate wires GL and the data wires DL. In addition, each of the plurality of sub-pixels SP can also be connected to power wires, such as a high potential wire, a low potential wire, and a reference wire.

The display panel PN can also include a non-display area NDA. The non-display area NDA is an area where an image is not displayed, and can be defined in an edge portion of the display panel PN to surround a portion or the entirety of the display area AA. The non-display area NDA can be an area adjacent to the display area AA. Further, the non-display area NDA can be an area disposed adjacent to the display area AA and configured to surround the display area AA. However, the present disclosure is not limited thereto.

For example, the non-display area NDA can include a first non-display area located outside the display area AA in a first direction, a second non-display area located outside the display area AA in a second direction intersecting the first direction, a third non-display area located outside the display area AA in the opposite direction to the first direction, and a fourth non-display area located outside the display area AA in the direction opposite to the second direction.

For another example, a boundary area between the display area AA and the non-display area NDA can be bent so that the non-display area NDA can be located below the display area. In this case, when the user looks at the display device from the front, there can be little or no non-display area NDA visible to the user.

The plurality of sub-pixels SP is the smallest units constituting a screen, and each of the plurality of sub-pixels SP can include a light-emitting element and a sub-pixel circuit to drive the light-emitting element.

The unit pixel is composed of a red (R) sub-pixel, a green (G) sub-pixel, and a blue (B) sub-pixel, or composed of a red (R) sub-pixel, a green (G) sub-pixel, a blue (B) sub-pixel, and a white (W) sub-pixel. However, the present disclosure is not limited thereto. A plurality of subpixels SP constituting unit pixel can be variously modified in colors and configurations, as necessary.

For example, each of the plurality of subpixels SP can emit light having different wavelengths from each other. For example, the plurality of subpixels SP can include red, green, and blue subpixels, in which the red, green, and blue subpixels can be disposed in a repeated manner. Alternatively, the plurality of subpixels SP can include red, green, blue, and white subpixels, in which the red, green, blue, and white subpixels can be disposed in a repeated manner, or the red, green, blue, and white subpixels can be disposed in a quad type. For example, the red sub pixel, the blue sub pixel, and the green sub pixel can be sequentially disposed along a row direction, or the red sub pixel, the blue sub pixel, the green sub pixel and the white sub pixel can be sequentially disposed along the row direction. However, in the embodiment of the present disclosure, the color type, disposition type, and disposition order of the subpixels are not limiting, and can be configured in various forms according to light-emitting characteristics, device lifespans, and device disclosures.

Meanwhile, the subpixels can have different light-emitting areas according to light-emitting characteristics. For example, a subpixel that emits light of a color different from that of a blue subpixel can have a different light-emitting area from that of the blue subpixel. For example, the red subpixel, the blue subpixel, and the green subpixel, or the red subpixel, the blue subpixel, the white subpixel, and the green subpixel can each has a different light-emitting area.

A plurality of light-emitting elements can be defined differently depending on the type of the display panel PN. For example, if the display panel PN is an inorganic light-emitting display panel, the light-emitting element can be a light-emitting diode (LED) or a micro light-emitting diode (micro LED).

The gate driver GD can supply a plurality of gate signals GS to a plurality of gate wires GL according to a plurality of gate control signals GCS provided from the timing controller TC. The number and arrangement of the gate driver GD are not limited to those shown. For example, the gate driver GD can be disposed on both sides or one side of the display panel PN, or can be disposed within the display area AA.

The data driver DD can convert the image data RGB input from the timing controller TC into a data voltage Vdata using a reference gamma voltage in accordance with a plurality of data control signals DCS provided from the timing controller TC. The data driver DD can supply the converted data voltage Vdata to the plurality of data wires DL. The data driver DD can be implemented as one or more source drive IC.

The timing controller TC can align the image data RGB input from the outside and supply the aligned image data to the data driver DD. The timing controller TC can generate a gate control signal GCS and a data control signal DCS using externally input synchronization signals, such as dot clock signals, data enable signals, and horizontal/vertical synchronization signals.

The timing controller TC can control the gate driver GD and the data driver DD by supplying the gate control signal GCS and the data control signal DCS to the gate driver GD and the data driver DD, respectively.

The timing controller TC can be mounted on a circuit board CB. The circuit board CB can be a printed circuit board or a flexible printed circuit board.

The timing controller TC receives digital video data and a timing signal from an external system board through a cable of the circuit board CB. The timing controller TC generates a gate control signal for controlling an operation timing of the gate driver GD and a source control signal for controlling the source drive IC, based on the timing signal. The timing controller TC supplies the gate control signal to the gate driver GD and supplies the source control signal to the source drive IC. Depending on the products, the timing controller TC can include the source drive IC and a single driving chip and mounted on the display panel. However, the present disclosure is not limited thereto.

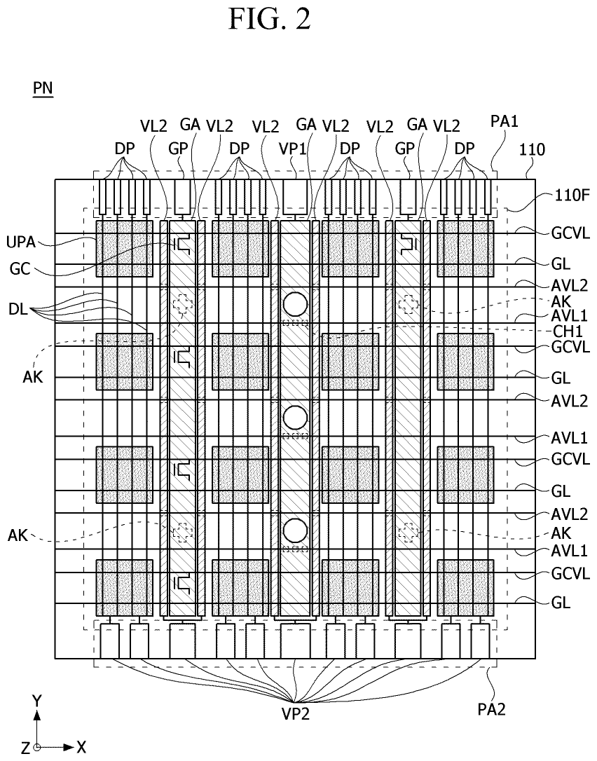

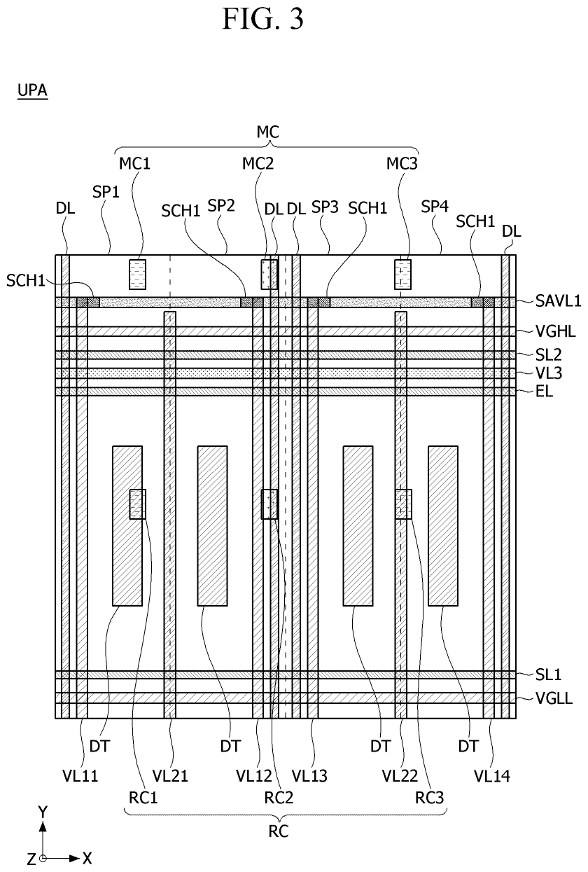

FIG. 2 is a schematic plan view of a display panel included in a display device according to one example embodiment of the present disclosure. FIG. 3 is a plan view of a unit pixel region included in a display device according to one example embodiment of the present disclosure.

Referring to FIGS. 2 and 3, a substrate 110 is configured to support the various components included in the display panel PN, and can be made of an insulating material. For example, the substrate 110 of the display panel PN can be made of glass or resin. Additionally, the substrate 110 can comprise a polymer or plastic, or can be made of a material having flexibility. For example, the substrate can include a flexible polymer film. For example, the flexible polymer film can be made of any one of polyimide (PI), polyethylene terephthalate (PET), acrylonitrile-butadiene-styrene copolymer(ABS), polymethyl methacrylate(PMMA), polyethylene naphthalate (PEN), polycarbonate (PC), polyethersulfone (PES), polyarylate (PAR), polysulfone (PSF), cyclic olefin copolymer(COC), triacetylcellulose(TAC), polyvinyl alcohol(PVA), and polystyrene(PS). For example, the substrate can include a transparent polyimide material, and the present disclosure is not limited thereto.

The display area AA can include a plurality of unit pixel regions UPA. Each of the unit pixel regions UPA can include a pixel region in which sub-pixels SP1, SP2, SP3, and SP4 are provided, and a non-pixel region in which no sub-pixel is provided. Circuit elements of the gate driving circuit can be positioned in the non-pixel region. The unit pixel region UPA can include at least two sub-pixels SP. The unit pixel region UPA can include four sub-pixels SP1, SP2, SP3, and SP4, but the example embodiments of the present disclosure are not limited thereto. The four sub-pixels can be a first sub-pixel SP1, a second sub-pixel SP2, a third sub-pixel SP3, and a fourth sub-pixel SP4.

Each of the plurality of sub-pixels can serve as an individual unit that emits light, and light emitting elements MC and RC and a sub-pixel circuit can be positioned in each of the plurality of sub-pixels. A sub-pixel unit including four sub-pixels SP1, SP2, SP3, and SP4 can include sub-pixels that emit light of at least two colors among a red sub-pixel, a green sub-pixel, and a blue sub-pixel, or can include sub-pixels that emit light of at least two colors among a red sub-pixel, a green sub-pixel, a blue sub-pixel, and a white sub-pixel, but the present disclosure is not limited thereto.

The sub-pixel unit can include at least two sub-pixels including a light emitting element having the lowest efficiency among a red light emitting element, a green light emitting element, and a blue light emitting element. In the case of an LED, the red light emitting element exhibits relatively low efficiency.

The sub-pixel circuit can include a driving transistor DT that provides a driving current to the light emitting elements MC and RC, and some of the plurality of light emitting elements MC and RC can be positioned to overlap the driving transistor DT.

The display device 100 according to one example embodiment of the present disclosure can include the first and second sub-pixels SP1 and SP2 that emit red light, the third sub-pixel SP3 that emits green light, and the fourth sub-pixel SP4 that emits blue light, and the first sub-pixel SP1, the second sub-pixel SP2, the third sub-pixel SP3, and the fourth sub-pixel SP4 can be arranged side by side in a first direction (e.g., an X-axis direction).

As mentioned above, the display area is an area in which the plurality of sub-pixel units are positioned, and a non-display area is an area in which no sub-pixel unit is positioned and no image is displayed. In the non-display area, the gate driver GD for driving the plurality of sub-pixels SP arranged in the display area, wires, and pads for applying signals to the wires can be positioned. In one example embodiment, at least a portion of the gate driver can be mounted in the display panel.

The gate driver GD can supply gate signals to the plurality of sub-pixels SP through the gate wire GL. The gate signals can include a scan signal and an emission signal.

The scan signal can be provided through a scan wire SL and the emission signal can be provided through an emission wire EL. Both the scan wire SL and the emission wire EL can be referred to as the gate wire GL.

Depending on the case, the scan wire SL can be a single wire or can include two or more wires. In the present disclosure, the scan wire SL can be described, by way of example, as including a first scan wire SL1 and a second scan wire SL2.

The gate driver GD can include a scan driver that provides the scan signal and a light emitting driver that provides the emission signal.

In the display device 100 according to one example embodiment of the present disclosure, at least a portion of the gate driver GD can be divided into a plurality of parts on the substrate 110 and positioned in gate driving circuit regions GA located between the plurality of unit pixel regions UPA.

In the display device 100 according to one example embodiment of the present disclosure, the light emitting element can be a light emitting diode (LED, an inorganic light emitting element). Since the LED exhibits excellent luminous efficiency, an area occupied by the light emitting elements MC and RC can be very small relative to the unit pixel region UPA. The sub-pixel circuit can be positioned in each of the sub-pixels SP1, SP2, SP3, and SP4, and at least one light emitting element MC or RC connected to the sub-pixel circuit can be provided. Additionally, a gate driving circuit GC can be positioned in the non-display area for each of at least one unit pixel region UPA.

The light emitting elements MC and RC can be positioned on the substrate 110 through a transfer process, and in this case, an alignment key AK for aligning the light emitting elements MC and RC with the substrate 110 can be provided in the gate driving circuit region GA. The alignment key AK can be positioned between the gate driving circuits GC arranged in a second direction (e.g., a Y-axis direction) in the gate driving circuit region GA.

The gate driving circuit region GA can be positioned in the second direction (e.g., the Y-axis direction) between adjacent unit pixel regions UPA, and the gate driving circuit GC can be positioned in the gate driving circuit region GA. The gate driving circuit GC can be electrically connected to the plurality of gate driving circuits GC arranged in the first direction (e.g., the X-axis direction) to provide the gate signals to the sub-pixels arranged in the same row. In this case, a gate driving wire GCVL for transmitting a signal to enable the gate driving circuit GC to operate can be positioned in the first direction (e.g., the X-axis direction). The gate driving wire GCVL can include a high voltage wire VGHL and a low voltage wire VGLL. The high voltage wire VGHL and the low voltage wire VGLL can be positioned in the first direction (e.g., the X-axis direction) in the unit pixel region UPA.

As described above, since the gate driver includes the scan driver and the light emitting driver, the gate driving circuit GC can include a scan driving circuit and a light emitting driving circuit. The gate driving circuit can also be referred to as the scan driving circuit or the light emitting driving circuit. The gate driving wire can be referred to as a scan driving wire or a light emitting driving wire. The scan driving circuit and the light emitting driving circuit can be positioned in the same row but in different regions.

The data driver DD can convert image data into a data signal and supply the converted data signal to the sub-pixels SP1, SP2, SP3, and SP4 through the data wire DL. The data driver DD can be formed on the rear surface of the substrate 110 or can be formed on a separate substrate. When the data driver DD is formed on one surface of the separate substrate, the other surface of the separate substrate on which the data driver DD is not formed can be bonded to the rear surface of the substrate 110 such that they face each other.

In order to electrically connect the front surface and the rear surface of the substrate 110 or to electrically connect the front surface of the substrate 110 and the other surface of the separate substrate, a side wire can be provided on the side surface of the substrate 110 or on the side surfaces of both the substrate 110 and the separate substrate. Accordingly, the data driver positioned on the rear surface of the substrate 110 or the other surface of the separate substrate can supply the data signal to the sub-pixel SP through the side wire.

As described above, in the display device 100 according to one example embodiment of the present disclosure, the gate driver GD can be positioned between adjacent sub-pixel units on the substrate 110. However, the present disclosure is not limited thereto, and the gate driver GD can be positioned at one side or both sides of the substrate 110.

The gate wire GL can be positioned in the first direction (e.g., the X-axis direction) on the substrate 110, and the data wire DL can be positioned in the second direction (e.g., the Y-axis direction). The gate wire GL and the data wire DL can be provided in all of the sub-pixels SP, and can supply signals to the sub-pixel circuits provided in the sub-pixels SP.

Pad regions PA1 and PA2 in which pads are provided can be formed at opposite sides of the substrate 110, i.e., at the upper portion and the lower portion of the substrate 110 in the second direction (e.g., the Y-axis direction). In this case, a pad region formed at the upper portion of the substrate 110 can be referred to as a first pad region PA1, and a pad region formed at the lower portion of the substrate 110 can be referred to as a second pad region PA2. In the substrate 110, the first pad region PA1 and the second pad region PA2 can be opposite each other.

In the first pad region PA1, a data pad DP connected to the data wire DL, a gate pad GP connected to the gate driver GD, a high-potential voltage pad VP1 connected to a high-potential voltage wire, and a reference voltage pad connected to a reference voltage wire VL3 can be arranged. In this case, the data pads DP can be provided in a number corresponding to the number of the sub-pixels SP included in the sub-pixel unit. A data signal corresponding to pixel data is applied to the data pad DP. The high-potential voltage wire can be referred to as a first power wire, and the reference voltage wire VL3 can be referred to as a second power wire.

In the gate driver GD, a wire for providing various clock signals, a wire for providing a gate low voltage, and a wire for providing a gate high voltage can be positioned to transmit signals. The gate drivers GD can be arranged side by side in the second direction (e.g., the Y-axis direction), so that the wires for transmitting signals to the gate drivers GD can be aligned with the gate drivers GD. The wires for transmitting signals to the gate driver GD are referred to as the gate driving wires, and the gate driving wire can be positioned in the second direction (e.g., the Y-axis direction), and can be connected to the gate pad GP provided in the first pad region PA1 to receive a signal from the gate pad GP.

The high-potential voltage wire can be positioned in the second direction (e.g., the Y-axis direction) between adjacent unit pixel regions UPA. The high-potential voltage wire positioned in the second direction (e.g., the Y-axis direction) can provide a high-potential voltage to the plurality of sub-pixels SP through the high-potential voltage pad VP1 located in the first pad region PA1. The plurality of high-potential voltage wires VL1 positioned in the second direction (e.g., the Y-axis direction) can be connected to an auxiliary high-potential voltage wire AVL1 positioned in the first direction (e.g., the X-axis direction) to form a mesh structure. The auxiliary high-potential voltage wire AVL1 can be positioned between adjacent unit pixel regions UPA in every row in which the sub-pixels are arranged, or in every multiple rows. The auxiliary high-potential voltage wire AVL1 can prevent a voltage drop on the high-potential voltage wire and can provide a high-potential voltage to the plurality of sub-pixels SP.

High-potential voltage wires VL11, VL12, VL13, and VL14 can be positioned in the second direction (e.g., the Y-axis direction) for the respective sub-pixels SP1, SP2, SP3, and SP4 arranged in the unit pixel region UPA. The plurality of high-potential voltage wires VL11, VL12, VL13, and VL14 positioned in the unit pixel region UPA can be connected to an auxiliary high-potential voltage wire SAVL1 positioned in the first direction (e.g., X-axis direction) in the unit pixel region UPA through contact holes SCH1 to form a mesh structure.

The high-potential voltage wires VL1, VL11, VL12, VL13, and VL14 and the auxiliary high-potential voltage wires AVL1 and SAVL1, which are positioned inside and outside the unit pixel region UPA, can be electrically connected to each other to form a mesh structure, and can receive a high-potential voltage through the high-potential voltage pad VP1.

A low-potential voltage pad VP2 connected to low-potential voltage wires VL2, VL21, and VL22 can be provided in the second pad region PA2. The low-potential voltage wires VL2, VL21, and VL22 can be positioned on both sides of the gate driving circuit region GA and between adjacent sub-pixels, and can provide a low-potential voltage to the sub-pixels. However, the present disclosure is not limited thereto, and the low-potential voltage wire can be positioned in each of the sub-pixels. The low-potential voltage wires VL2, VL21, and VL22 can be referred to as the second power wires.

The plurality of low-potential voltage wires VL21 and VL22 positioned in the second direction (e.g., the Y-axis direction) can be connected to an auxiliary low-potential voltage wire AVL2 positioned in the first direction (e.g., the X-axis direction). The auxiliary low-potential voltage wire AVL2 can be positioned in every row in which the unit pixel regions UPA are arranged, or in every multiple rows. The auxiliary low-potential voltage wire AVL2 can prevent a voltage drop on the low-potential voltage wires VL21 and VL22, and can provide a low-potential voltage to the plurality of sub-pixels.

The reference voltage wire VL3 can be positioned in the first direction (e.g., the X-axis direction) for each of the unit pixel regions UPA arranged in the first direction (e.g., the X-axis direction). The reference voltage wire VL3 positioned in the first direction (e.g., the X-axis direction) can provide a reference voltage to the sub-pixel unit through a wire separately positioned in the second direction (e.g., the Y-axis direction). The reference voltage wire VL3 can be connected to the reference voltage pad located in the first pad region PA1, and the reference voltage can be provided to the plurality of reference voltage wires VL3 through the reference voltage pad.

In the display panel PN included in the display device 100 according to one example embodiment of the present disclosure, the edge of the substrate 110 can be removed by grinding in order to reduce a bezel.

The bezel refers to the edge region of the substrate 110 in which the sub-pixels SP1, SP2, SP3, and SP4 are not provided. During the grinding process, portions of pads and wires positioned at the edge of the substrate 110 can be removed, and the size of the substrate 110 can be reduced, so that the display panel PN can be implemented with the size of a final substrate 110F.

Specifically, in the final substrate 110F, most of the pads arranged in the first pad region PA1 and the second pad region PA2 can be removed, and only a portion or traces of the pads can remain.

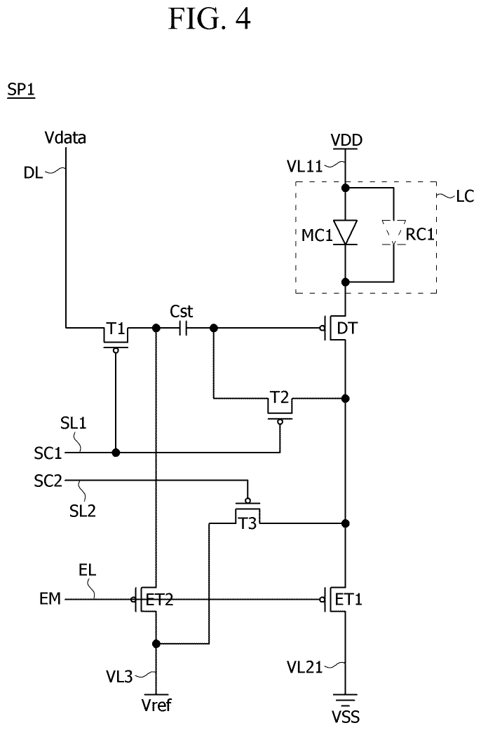

FIG. 4 is a circuit diagram of a sub-pixel included in a display device according to one example embodiment of the present disclosure. Although the illustrated circuit diagram is assumed to be the sub-pixel circuit included in the first sub-pixel SP1, this can also be applied to the sub-pixel circuits included in the other sub-pixels SP2, SP3, and SP4.

Referring to FIG. 4, the first sub-pixel SP1 can include a light emitting element LC and the sub-pixel circuit configured to provide a driving current to the light emitting element LC.

The light emitting element LC can include a first main light emitting element MC1 and a first auxiliary light emitting element RC1, but is not limited thereto. For example, assuming that the sub-pixel circuit included in the first sub-pixel SP1 is referred to as a first sub-pixel circuit, the sub-pixel circuit included in the second sub-pixel SP2 is referred to as a second sub-pixel circuit, the sub-pixel circuit included in the third sub-pixel SP3 is referred to as a third sub-pixel circuit, and the sub-pixel circuit included in the fourth sub-pixel SP4 is referred to as a fourth sub-pixel circuit, the first sub-pixel circuit can be connected to the first main light emitting element MC1, the second sub-pixel circuit can be connected to the first auxiliary light emitting element RC1, the third sub-pixel circuit can be connected to a second main light emitting element MC2 and a second auxiliary light emitting element RC2, and the fourth sub-pixel circuit can be connected to a third main light emitting element MC3 and a third auxiliary light emitting element RC3. Among these, when two light emitting elements are connected to one sub-pixel circuit, the two light emitting elements can be connected in parallel with each other.

The first main light emitting element MC1 and the first auxiliary light emitting element RC1 can be arranged in parallel, but are not limited thereto.

The anode electrode of the first main light emitting element MC1 and the anode electrode of the first auxiliary light emitting element RC1 can be connected to the high-potential voltage wire VL11 to which a high-potential voltage VDD is supplied. The cathode electrode of the first main light emitting element MC1 and the cathode electrode of the first auxiliary light emitting element RC1 can be connected to the sub-pixel circuit.

The sub-pixel circuit can include six transistors and one capacitor.

The transistor can be a thin-film transistor, and can be either an n-channel or a p-channel transistor. In the present disclosure, the transistor will be described as a p-channel transistor. However, the example embodiments of the present disclosure are not limited thereto. In addition, the transistor can be formed of a semiconductor material such as an oxide semiconductor, amorphous silicon, or polysilicon, but is not limited thereto.

The oxide semiconductor material can have an excellent effect of preventing a leakage current and relatively inexpensive manufacturing cost. The oxide semiconductor can be made of a metal oxide such as zinc (Zn), indium (In), gallium (Ga), tin (Sn), and titanium (Ti) or a combination of a metal such as zinc (Zn), indium (In), gallium (Ga), tin (Sn), or titanium (Ti) and its oxide. Specifically, the oxide semiconductor can include zinc oxide (ZnO), zinc-tin oxide (ZTO), zinc-indium oxide (ZIO), indium oxide (InO), titanium oxide (TiO), indium-gallium-zinc oxide (IGZO), indium-zinc-tin oxide (IZTO), indium zinc oxide (IZO), indium gallium tin oxide (IGTO), and indium gallium oxide (IGO), but is not limited thereto.

The polycrystalline semiconductor material has a fast movement speed of carriers such as electrons and holes and thus has high mobility, and has low energy power consumption and superior reliability. The polycrystalline semiconductor can be made of polycrystalline silicon (poly-Si), but is not limited thereto.

The amorphous semiconductor material can be made of amorphous silicon (a-Si), but is not limited thereto.

The driving transistor DT can include a gate electrode, a source electrode, and a drain electrode, wherein the gate electrode can be connected to one electrode of a capacitor Cst, the source electrode can be connected to the cathode electrodes of the first main light emitting element MC1 and the first auxiliary light emitting element RC1, and the drain electrode can be connected to the source electrode of a first light emitting transistor ET1. The driving transistor DT can be controlled by a voltage applied to the gate electrode to control the voltage at the cathode electrodes of the first main light emitting element MC1 and the first auxiliary light emitting element RC1. Accordingly, the first main light emitting element MC1 and the first auxiliary light emitting element RC1 can emit light.

A first transistor T1 can include a gate electrode, a source electrode, and a drain electrode, wherein the gate electrode can be connected to the first scan wire SL1, the source electrode can be connected to the data wire DL, and the drain electrode can be connected to the other electrode of the capacitor Cst. The first transistor T1 can be controlled by a first scan signal SC1 to provide the data voltage Vdata to the other electrode of the capacitor Cst.

A second transistor T2 can include a gate electrode, a source electrode, and a drain electrode, wherein the gate electrode can be connected to the first scan wire SL1, the source electrode can be connected to one electrode of the capacitor Cst, and the drain electrode can be connected to the drain electrode of the driving transistor DT. The second transistor T2 can be controlled by the first scan signal SC1 to electrically connect the gate electrode of the driving transistor DT to the drain electrode of the driving transistor DT, thereby forming a diode connection. Accordingly, the second transistor T2 can sample the threshold voltage of the driving transistor DT.

A third transistor T3 can include a gate electrode, a source electrode, and a drain electrode, wherein the gate electrode can be connected to the second scan wire SL2, the source electrode can be connected to the drain electrode of the driving transistor DT, and the drain electrode can be connected to the reference voltage wire VL3. The third transistor T3 can be controlled by a second scan signal SC2 to provide a reference voltage Vref to the drain electrode of the driving transistor DT.

The first light emitting transistor ET1 can include a gate electrode, a source electrode, and a drain electrode, wherein the gate electrode can be connected to the emission wire EL, the source electrode can be connected to the drain electrode of the driving transistor DT, and the drain electrode can be connected to the low-potential voltage wire VL21. The first light emitting transistor ET1 can be controlled by an emission signal EM to provide a low-potential voltage VSS to the drain electrode of the driving transistor DT.

A second light emitting transistor ET2 can include a gate electrode, a source electrode, and a drain electrode, wherein the gate electrode can be connected to the emission wire EL, the source electrode can be connected to the other electrode of the capacitor Cst and the drain electrode of the first transistor T1, and the drain electrode can be connected to the reference voltage wire VL3. The second light emitting transistor ET2 can be controlled by the emission signal EM to provide the reference voltage Vref to the other electrode of the capacitor Cst and the drain electrode of the first transistor T1.

The source electrodes and/or drain electrodes of the transistors described above can be referred to differently depending on the type of the transistor or the voltage applied thereto.

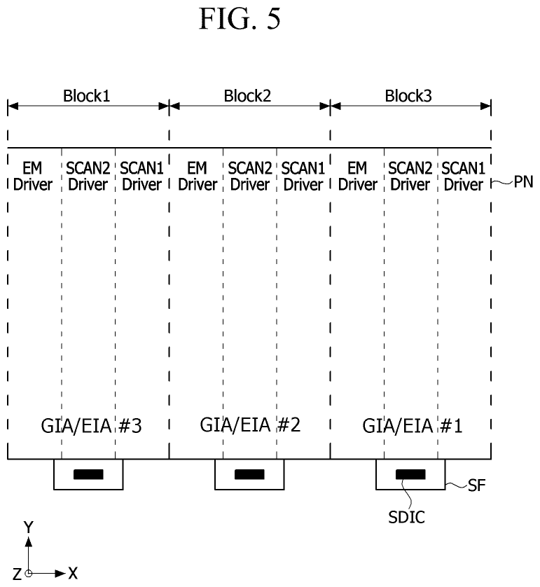

FIG. 5 is a diagram illustrating an arrangement method of a gate driver in a display device according to one example embodiment of the present disclosure. FIG. 5 illustrates a configuration of a gate driver that supplies a driving signal to the sub-pixel circuit shown in FIG. 4.

The sub-pixel circuit can be driven by receiving the first scan signal SC1, the second scan signal SL2, and the emission signal EM. The gate driver can include a first scan driver (SCAN1 Driver) that sequentially outputs the first scan signal SC1, a second scan driver (SCAN2 Driver) that sequentially outputs the second scan signal SC2, and an emission driver (EM Driver) that sequentially outputs the emission signal EM.

In FIG. 4, each of the subpixels has 6T(Transistor)1C(Capacitor) structure including six transistors and one capacitor, but not limited thereto. Each of the subpixels can further include a compensation circuit CC. In this case, various structures such as 4T2C, 5T2C, 6T2C, 7T1C, 7T2C, and the like can be provided.

Referring to FIG. 5, the entire region of the display panel PN can be divided into three blocks Block1, Block2, and Block3 and can be driven accordingly. Here, the blocks Block1, Block2, and Block3 can include gate drivers GIA/EIA #1, GIA/EIA #2, and GIA/EIA #3, each including the first scan driver (SCAN1 Driver), the second scan driver (SCAN2 Driver), and the emission driver (EM Driver). The gate drivers GIA/EIA #1, GIA/EIA #2, and GIA/EIA #3 can be positioned in the pixel region.

In the display device 100 according to one example embodiment of the present disclosure, the gate driver GD can be implemented in a gate driver in array (GIA) scheme in which scan drivers are positioned between pixel regions, and in an emission driver in array (EIA) scheme in which light emitting drivers are positioned between pixel regions.

The sub-pixels in each of the blocks Block1, Block2, and Block3 can be electrically connected to a source driver IC SDIC that supplies a data signal to each sub-pixel. The number and arrangement method of the gate drivers GIA/EIA #1, GIA/EIA #2, and GIA/EIA #3 and the source driver ICs SDIC provided in the display panel PN are merely one example embodiment, and the number and arrangement method can be variously modified and applied. The source driver IC SDIC can be mounted on a flexible film SF, e.g., a chip on film (COF). The source driver IC SDIC and wires to which various signals are applied can be positioned in the film. The film can be interpreted as an example of a source circuit.

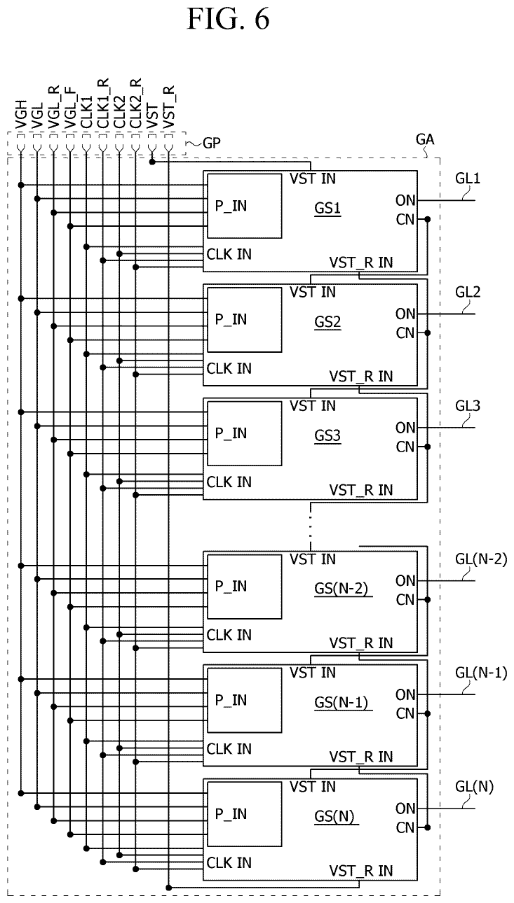

FIG. 6 is a diagram illustrating a configuration of a gate driver included in a display device according to one example embodiment of the present disclosure.

Referring to FIG. 6, the gate driver can include a plurality of stages GS1, GS2, GS3, . . . , GS(N−2), GS(N−1), and GS(N). The number of the plurality of stages is N, and N is a natural number.

The illustrated gate driver represents the light emitting driver.

A plurality of clock signal wires, a plurality of voltage wires, and a plurality of signal wires for driving the plurality of stages GS1, GS2, GS3, . . . , GS(N−2), GS(N−1), and GS(N) can be arranged in the gate driving circuit region GA.

The plurality of clock signal wires can include a first clock signal wire for providing a first clock signal CLK1, a first reverse clock signal wire for providing a first reverse clock signal CLK1_R, a second clock signal wire for providing a second clock signal CLK2, and a second reverse clock signal wire for providing a second reverse clock signal CLK2_R.

The plurality of voltage wires can include a high voltage wire for providing the gate high voltage VGH, a low driving voltage wire for providing the low driving voltage VGL, a forward low driving voltage wire for providing a forward low driving voltage VGL_F, and a reverse low driving voltage wire for providing a reverse low driving voltage VGL_R.

The plurality of signal wires can include a start signal wire for providing a start signal VST, a reverse start signal wire for providing a reverse start signal VST_R, and a reset signal wire for providing a reset signal.

The plurality of stages GS1, GS2, GS3, . . . , GS(N−2), GS(N−1), and GS(N), the plurality of clock signal wires, and the plurality of voltage wires can be arranged in the gate driving circuit region GA, and the gate pads GP that provide signals can be positioned at the ends of the plurality of clock signal wires and the plurality of voltage wires.

Each of the plurality of stages GS1, GS2, GS3, . . . , GS(N−2), GS(N−1), and GS(N) can include a low power input node P_IN and clock signal input node CLK IN. The power input P_IN can include a plurality of nodes and can receive voltages supplied from the plurality of voltage wires.

For example, when N is an even number, the odd-numbered stages GS1, GS3, . . . , GS(N−1) among the plurality of stages GS1, GS2, GS3, . . . , GS(N−2), GS(N−1), and GS(N) can be connected to the first clock signal wire for providing the first clock signal CLK1 and the first reverse clock signal wire for providing the first reverse clock signal CLK1_R.

In one example embodiment, the odd-numbered stages GS1, GS3, . . . , GS(N−1) can also be connected to the second clock signal wire for providing the second clock signal CLK2 and the second reverse clock signal wire for providing the second reverse clock signal CLK2_R.

The even-numbered stages GS2, . . . , GS(N−2), and GS(N) can be connected to the second clock signal wire for providing the second clock signal CLK2 and the second reverse clock signal wire for providing the second reverse clock signal CLK2_R.

In one example embodiment, the even-numbered stages GS2, . . . , GS(N−2), and GS(N) can also be connected to the first clock signal wire for providing the first clock signal CLK1 and the first reverse clock signal wire for providing the first reverse clock signal CLK1_R.

Each of the plurality of stages GS1, GS2, GS3, . . . , GS(N−2), GS(N−1), and GS(N) can include a start signal node VST IN that receives the start signal VST, and a reverse start signal node VST_R IN that receives the reverse start signal VST_R. In this case, the start signal node VST IN of a first stage GS1 can be connected to the start signal wire for providing the start signal VST, and the reverse start signal node VST_R IN of an N^{th} stage GS(N) can be connected to the reverse start signal wire for providing the reverse start signal VST_R.

The start signal node VST IN of each of a second stage GS2 to an (N−1)^{th} stage GS(N−1) can be connected to a carry node CN of its preceding stage to receive a carry signal. The reverse start signal node VST_R IN of each of the second stage GS2 to the (N−1)^{th} stage GS(N−1) can be connected to the carry node CN of its subsequent stage to receive a carry signal.

An output node ON included in each of the plurality of stages GS1, GS2, GS3, . . . , GS(N−2), GS(N−1), and GS(N) can be connected to the gate wire and can output a gate signal. The first stage GS1 can be connected to a first gate wire GL1, the second stage GS2 can be connected to a second gate wire GL2, the third stage GS3 can be connected to a third gate wire GL3, the (N−2)^{th} stage GS(N−2) can be connected to an (N−2)^{th} gate wire GL(N−2), an (N−1)^{th} stage GS(N−1) can be connected to an (N−1)^{th} gate wire GL(N−1), and the N^{th} stage GS(N) can be connected to an N^{th} gate wire GL(N). In this case, the gate wire can be the emission wire.

The gate driver according to one example embodiment of the present disclosure can be sequentially driven from the first stage GS1 to the N^{th} stage GS(N) by the start signal VST to output gate signals, and can be sequentially driven in a reverse direction from the N^{th} stage GS(N) to the first stage GS1 by the reverse start signal VST_R to output gate signals. Accordingly, the gate driver according to one example embodiment of the present disclosure can enable bidirectional driving by using a single gate driver, thereby reducing cost.

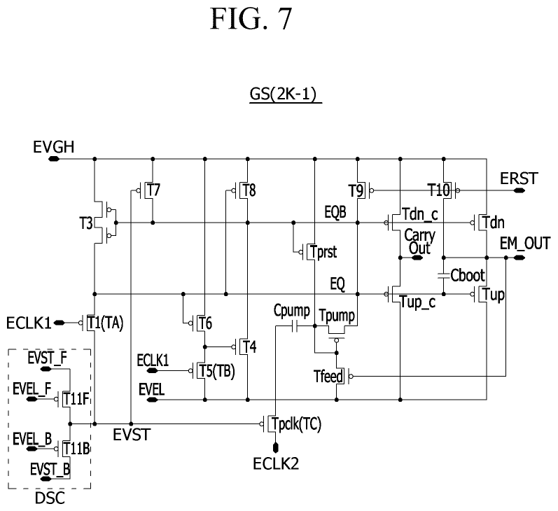

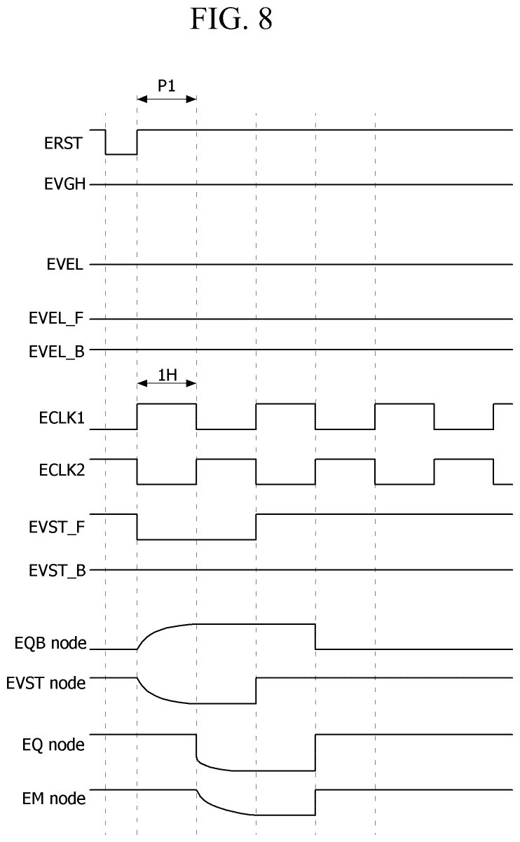

FIG. 7 is a diagram illustrating a light emitting driving circuit included in a gate driver according to an example embodiment of the present disclosure. FIG. 8 is a diagram illustrating a driving timing of the light emitting driving circuit shown in FIG. 7.

One light emitting driving circuit can be distributed across the plurality of gate driving circuit regions GA. Specifically, the light emitting driving circuit can be distributed across the plurality of gate driving circuit regions GA located in a row in which the emission wire EL, to which the emission signal EM is applied, is positioned. In addition, one light emitting driving circuit can be included in any one of the plurality of stages GS1, GS2, GS3, . . . , GS(N−2), GS(N−1), and GS(N) shown in FIG. 6.

The plurality of stages according to an example embodiment of the present disclosure can be classified into odd-numbered stages GS(2K−1) and even-numbered stages GS(2K), where K is a natural number. The odd-numbered stages GS(2K−1) and the even-numbered stages GS(2K) can be distinguished based on transistors T1, T5, and Tpclk to which a first clock signal ECLK1 and a second clock signal ECLK2 are inputted.

Transistors included in the light emitting driving circuit can be thin film transistors each having a gate electrode, a first source/drain electrode, and a second source/drain electrode, and can be p-channel transistors, but the example embodiments of the present disclosure are not limited thereto. The p-channel transistor can be turned on when the low driving voltage is applied to the gate electrode, and can be turned off when the high voltage is applied to the gate electrode.

Referring to FIGS. 7 and 8, the light emitting driving circuit serving as the gate driving circuit included in the odd-numbered stage GS(2K−1) can be driven by a high driving voltage EVGH, a low driving voltage EVEL, a forward low voltage EVEL_F, a reverse low voltage EVEL_B, a forward start signal EVST_F, a reverse start signal EVST_B, the first and second clock signals ECLK1 and ECLK2, and an emission control reset signal ERST, and can output a carry signal Carry Out and an emission signal EM OUT. The high driving voltage EVGH, the low driving voltage EVEL, the forward low voltage EVEL_F, and the reverse low voltage EVEL_B can be constant voltages (or DC voltages) output from a power IC. In the odd-numbered stage GS(2K−1), the first clock signal ECLK1 can be inputted to a first clock node connected to a first transistor T1 and a fifth transistor T5, and the second clock signal ECLK2 can be inputted to a second clock node connected to a clock transistor Tpclk.

The light emitting driving circuit can include a pull-up transistor Tup, a pull-down transistor Tdn, a plurality of transistors T1, T3, T4, T5, T6, T7, T8, T9, T10, Tup_c, Tdn_c, Tpump, Tfeed, Tpclk, and Tprst and at least one capacitor Cpump or Cboot for generating the emission signal, and a direction selection circuit DSC for selecting forward driving or reverse driving.

The pull-up transistor Tup can be electrically connected between a low driving voltage EVEL input terminal and an output terminal of the emission signal EM_OUT. The gate electrode of the pull-up transistor Tup is connected to a Q node EQ. The pull-up transistor Tup can be controlled by a voltage level of the Q node EQ. The low driving voltage EVEL can be, for example, a low potential driving voltage. The pull-up transistor Tup can control an output of the emission signal EM at a turn-on level to the gate line GL. The low driving voltage EVEL input terminal can be interpreted as an example of a first driving voltage wire.

The pull-down transistor Tdn can be electrically connected between a high driving voltage EVGH input terminal and the output terminal of the emission signal EM. The pull-down transistor Tdn can be controlled by a voltage level of a QB node EQB. The high driving voltage EVGH can be, for example, a high potential driving voltage. The pull-down transistor Tdn can control an output of the emission signal EM at a turn-off level to the gate line GL. The high driving voltage EVGH input terminal can be interpreted as an example of a second driving voltage wire.

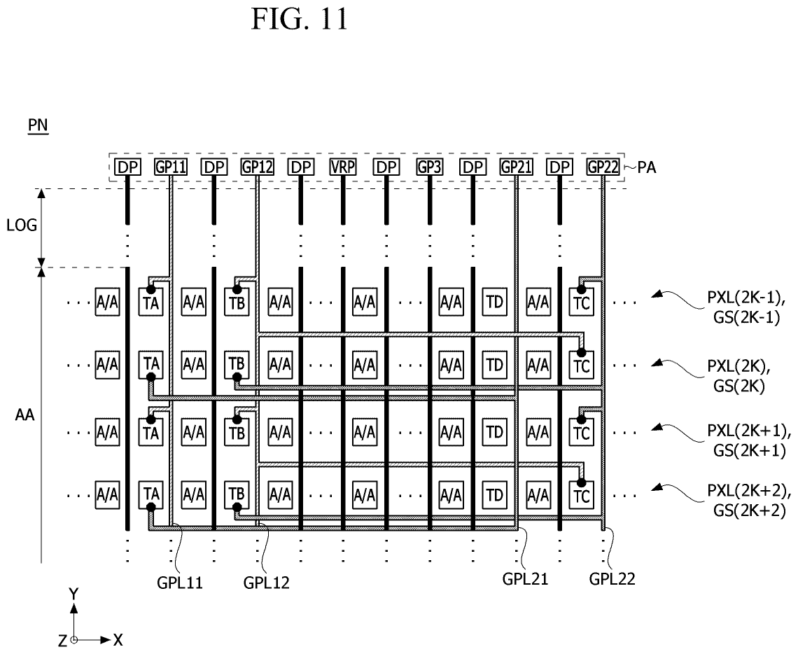

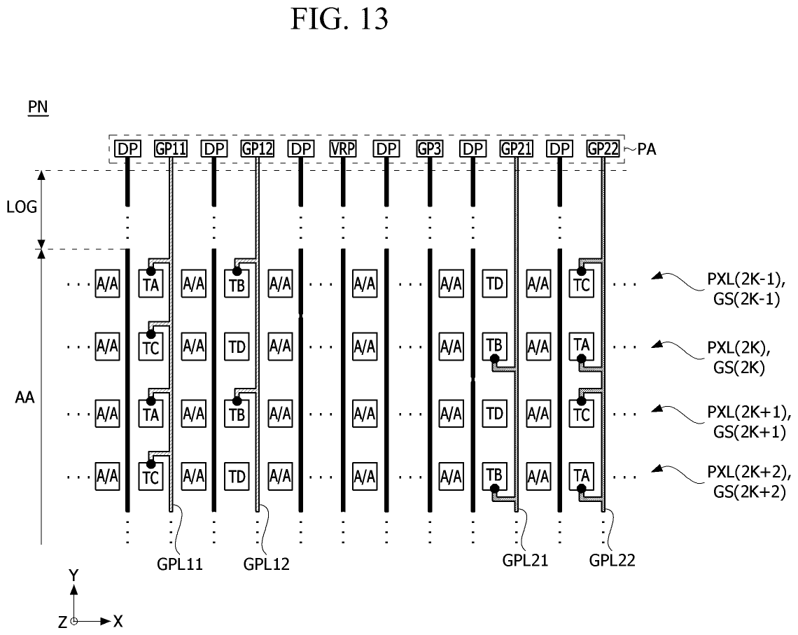

The first transistor T1 can be electrically connected between a start signal input node EVST and the Q node EQ. The first transistor T1 can operate in response to a voltage level of the first clock signal ECLK1. The first transistor T1 can be turned on when the first clock signal ECLK1 is at a low level, which is a turn-on level, to connect the start signal input node EVST to the Q node EQ. The first transistor T1 can include a first electrode connected to the Q node EQ, a gate electrode connected to the first clock node, and a second electrode connected to the start signal input node EVST. The first transistor T1 can be interpreted as an example of a transistor A (TA) in FIGS. 11 and 13.

A third transistor T3 can be electrically connected between the high driving voltage EVGH input terminal and the Q node EQ. The third transistor T3 can operate in response to a voltage level of the QB node EQB.

A fourth transistor T4 can be electrically connected between the low driving voltage EVEL input terminal and the QB node EQB. The fourth transistor T4 can operate in response to a voltage level of a node between the fifth transistor T5 and a sixth transistor T6.

The fifth transistor T5 and the sixth transistor T6 can be electrically connected between the low driving voltage EVEL input terminal and the high driving voltage EVGH input terminal. The fifth transistor T5 can operate in response to a voltage level of the first clock signal ECLK1. The sixth transistor T6 can operate in response to a voltage level of the Q node EQ. The fifth transistor T5 can include a first electrode connected to the second electrode of the sixth transistor T6 and the gate electrode of the fourth transistor T4, a gate electrode connected to the first clock node, and a second electrode connected to the low driving voltage EVEL input terminal. The fifth transistor T5 can be interpreted as an example of a transistor B (TB) in FIGS. 11 and 13.

By the operations of the fourth, fifth, and sixth transistors T4, T5, and T6, when the Q node EQ is at a low voltage, a high voltage can be maintained at the QB node EQB, and when the Q node EQ is at a high voltage, a low voltage can be applied to the QB node EQB. When the Q node EQ is at a low voltage, the sixth transistor T6 can be turned on to apply the high driving voltage EVGH to the gate electrode of the fourth transistor T4, thereby turning off the fourth transistor T4 and maintaining the high driving voltage EVGH at the QB node EQB. When the Q node EQ is at a high voltage, the sixth transistor T6 can be turned off, and the fourth transistor T4 can be turned on by the fifth transistor T5 that is turned on. The turned-on fourth transistor T4 can provide the low driving voltage EVEL to the QB node EQB.

A seventh transistor T7 and an eighth transistor T8 can be electrically connected between the high driving voltage EVGH input terminal and the QB node EQB. The seventh transistor T7 can operate in response to a signal supplied to the start signal input node EVST. The eighth transistor T8 can operate in response to a voltage level of the Q node EQ. When the Q node EQ is at a low voltage, the eighth transistor T8 can set and maintain the QB node EQB at the high driving voltage EVGH.

A ninth transistor T9 can be electrically connected between the high driving voltage EVGH input terminal and the Q node EQ. A tenth transistor T10 can be electrically connected between the high driving voltage EVGH input terminal and the output terminal of the emission signal EM. The ninth transistor T9 and the tenth transistor T10 can operate in response to the emission control reset signal ERST.

A pull-up transistor Tup_c and a pull-down transistor Tdn_c for the output of the carry signal Carry can be provided separately from the pull-up transistor Tup and the pull-down transistor Tdn for the output of the emission signal EM. The pull-up transistor Tup_c and the pull-down transistor Tdn_c for the output of the carry signal can operate simultaneously with the pull-up transistor Tup or the pull-down transistor Tdn for the output of the emission signal EM to output the carry signal Carry.

A boot capacitor Cboot can be electrically connected between the Q node EQ and the output terminal of the emission signal EM. The Q node EQ can be coupled to the output terminal of the emission signal EM by the boot capacitor Cboot. At a time point when a turn-on level of the emission signal EM is outputted as a voltage level at the output terminal of the emission signal EM is lowered, a voltage level at the Q node EQ can be lowered by the boot capacitor Cboot.

A pump capacitor Cpump can be electrically connected between a pump transistor Tpump and the clock transistor Tpclk. The pump capacitor Cpump can be connected to the Q node EQ when the pump transistor Tpump is turned on, and can be electrically connected to a second clock signal ECLK2 input terminal when the clock transistor Tpclk is turned on. The pump capacitor Cpump can maintain a voltage level of the Q node EQ at a sufficiently low voltage level during a period in which a turn-on level of the emission signal EM is maintained.

The pump transistor Tpump can be electrically connected between the pump capacitor Cpump and the Q node EQ. The gate node of the pump transistor Tpump can be electrically connected to a node between the feed transistor Tfeed and the pump capacitor Cpump. The pump transistor Tpump can operate in response to a signal supplied through the feed transistor Tfeed.

The feed transistor Tfeed can be electrically connected between the gate electrode of the pump transistor Tpump and the low driving voltage EVEL input terminal. The feed transistor Tfeed can operate in response to a voltage level of the emission signal EM.

The clock transistor Tpclk can be electrically connected between the pump capacitor Cpump and the second clock node. The clock transistor Tpclk can operate in response to a voltage level of the start signal input node EVST to which the forward or reverse start signal EVST_F or EVST_B is inputted. The clock transistor Tpclk can include a first electrode connected to the pump capacitor Cpump, a gate electrode connected to the start signal input node EVST, and a second electrode connected to the second clock node. The clock transistor Tpclk can be interpreted as an example of a transistor C (TC) in FIGS. 11 and 13.

The reset transistor Tprst can be electrically connected between the high driving voltage EVGH input terminal and the pump capacitor Cpump. The reset transistor Tprst can be electrically connected to the gate node of the pump transistor Tpump. The reset transistor Tprst can operate in response to a voltage level of the QB node EQB.

When the emission control reset signal ERST at a turn-on level is supplied, the ninth transistor T9 and the tenth transistor T10 can be turned on, and the high driving voltage EVGH can be supplied to the Q node EQ and to the output terminal of the emission signal EM. The Q node EQ can be maintained at a high level, the QB node EQB can be maintained at a low level, and the emission signal EM at a turn-off level can be outputted.

The direction selection circuit DSC can apply either the forward start signal EVST_F for forward operation of the light emitting driving circuit or the reverse start signal EVST_B for reverse operation of the light emitting driving circuit to the start signal input node EVST.

The direction selection circuit DSC can include a forward selection transistor T11F and a reverse selection transistor T11B.

The forward selection transistor T11F is a transistor for forward operation. The gate electrode of the forward selection transistor T11F can be connected to the forward low voltage EVEL_F, the first source/drain electrode thereof can be connected to a forward start signal EVST_F wire, and the second source/drain electrode thereof can be connected to the start signal input node EVST. Accordingly, when the forward low voltage EVEL_F is inputted, the forward selection transistor T11F can apply the forward start signal EVST_F to the start signal input node EVST.

The reverse selection transistor T11B is a transistor for reverse operation. The gate electrode of the reverse selection transistor T11B can be connected to the reverse low voltage EVEL_B, the first source/drain electrode thereof can be connected to a reverse start signal EVST_B wire, and the second source/drain electrode thereof can be connected to the start signal input node EVST. Accordingly, when the reverse low voltage EVEL_B is inputted, the reverse selection transistor T11B can apply the reverse start signal EVST_B to the start signal input node EVST.

As shown in the waveform diagram of FIG. 8, during forward operation, the forward low voltage EVEL_F can be maintained at a low level, and the reverse low voltage EVEL_B can be maintained at a high level. Accordingly, while the forward operation is being performed, the forward selection transistor T11F can remain in a continuously turned-on state, and the reverse selection transistor T11B can remain in a turned-off state. Conversely, during reverse operation, the forward low voltage EVEL_F can be maintained at a high level, and the reverse low voltage EVEL_B can be maintained at a low level. Accordingly, while the reverse operation is being performed, the forward selection transistor T11F can remain in a continuously turned-off state, and the reverse selection transistor T11B can remain in a turned-on state.

During the forward operation of the light emitting driving circuit, the forward selection transistor T11F can be turned on by the forward low voltage EVEL_F to apply the forward start signal EVST_F to the start signal input node EVST. The forward selection transistor T11F can provide a low voltage of the forward start signal EVST_F to the Q node, thereby allowing the emission signal EM to be outputted.

During the reverse operation of the light emitting driving circuit, the reverse selection transistor T11B can be turned on by the reverse low voltage EVEL_B to apply the reverse start signal EVST_B to the start signal input node EVST. The reverse selection transistor T11B can provide the low voltage of the reverse start signal EVST_B to the Q node, thereby allowing the emission signal EM to be outputted.

Referring to FIG. 8, the emission control reset signal ERST can be outputted to reset the operation of the light emitting driving circuit before a frame starts. When the emission control reset signal ERST is applied at a low level, the ninth transistor T9 and the tenth transistor T10 can be turned on. The turned-on ninth transistor T9 can apply the high driving voltage EVGH to the Q node EQ. The turned-on tenth transistor T10 can apply the high driving voltage EVGH to the output terminal of the emission signal EM. Accordingly, the Q node EQ and the output terminal of the emission signal EM can be discharged to the high driving voltage EVGH.

The high driving voltage EVGH and the low driving voltage EVEL can be fixedly supplied to the light emitting driving circuit. The high driving voltage EVGH and the low driving voltage EVEL can each maintain a constant voltage regardless of forward operation and reverse operation.

The forward low voltage EVEL_F and the reverse low voltage EVEL_B can be applied according to a driving direction of the light emitting driving circuit. During forward driving, the forward low voltage EVEL_F can be applied as a low-level voltage, and the reverse low voltage EVEL_B can be maintained at a high level. Since FIG. 8 illustrates a driving waveform in forward driving, the forward low voltage EVEL_F is shown as being applied as a low-level voltage and the reverse low voltage EVEL_B is shown as being applied as a high-level voltage. During reverse driving, the reverse low voltage EVEL_B can be applied as a low-level voltage, and the forward low voltage EVEL_F can be maintained at a high level.

The clock signals ECLK1 and ECLK2 can be pulse signals having a constant period, signal magnitude, and duty ratio. The clock signals ECLK1 and ECLK2 can include a first level (e.g., low level) and a second level (e.g., high level). For example, the clock signal ECLK1 can include a first level (e.g., low level) and a second level (e.g., high level), and the clock signal ECLK2 can include a first level (e.g., low level) and a second level (e.g., high level). The clock signals ECLK1 and ECLK2 can each be a signal in which the first level and the second level alternate, and one period can be defined as a combination of a duration of the first level and a duration of the second level. The first clock signal ECLK1 and the second clock signal ECLK2 can be inputted to the odd-numbered stage and the even-numbered stage, and the number of clock signals can vary depending on a driving method of the light emitting driver.

The forward start signal EVST_F and the reverse start signal EVST_B are pulse signals having a preset period and magnitude. Based on one period 1H during which the clock signals ECLK1 and ECLK2 maintain a constant value, the forward start signal EVST_F or the reverse start signal EVST_B can be supplied for a duration of two periods 2H. One period 1H can be one horizontal period. In forward driving, the forward start signal EVST_F can be applied as a low-level voltage, and the reverse start signal EVST_B can be maintained at a high level. Since FIG. 8 illustrates a driving waveform in forward driving, the forward start signal EVST_F is shown as being applied as a low-level pulse, and the reverse start signal EVST_B is shown as being maintained at a high level. On the other hand, in reverse driving, the reverse start signal EVST_B can be applied as a low-level pulse, and the forward start signal EVST_F can be maintained at a high level.

Referring to voltage changes at the QB node EQB, the start signal input node EVST, the Q node EQ, and an EM node included in the light emitting driving circuit, when the forward start signal EVST_F is inputted at a low level, the start signal input node EVST can begin to be charged to a low level, and simultaneously, the QB node EQB can begin to be discharged to a high level.

During a 2H period in which the forward start signal EVST_F is inputted at a low level, the start signal input node EVST can also be charged to a low level. When the forward start signal EVST_F transitions to a high level, the start signal input node EVST can be discharged to a high level.

The QB node EQB can begin to be discharged to a high level simultaneously with the charging of the start signal input node EVST to a low level, and can maintain the discharged state at a high level for a 1H period after the start signal input node EVST is discharged to a high level.

The Q node EQ and the output terminal (the EM node) of the emission signal EM can begin to be charged to a low level starting from a period following a 1H period during which the start signal input node EVST is charged to a low level, and can maintain the charged state at a low level for a 2H period until the 1H period during which the start signal input node EVST is discharged to a high level.

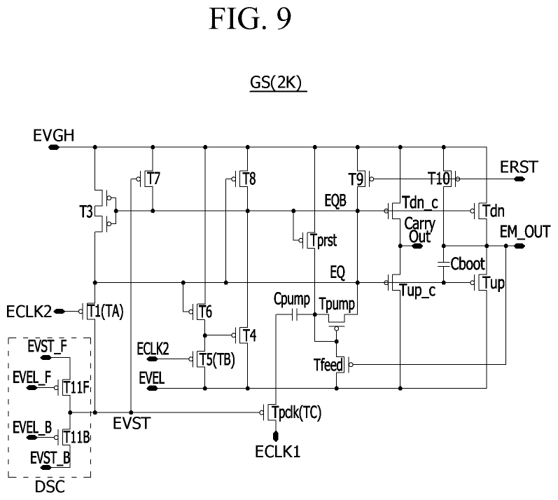

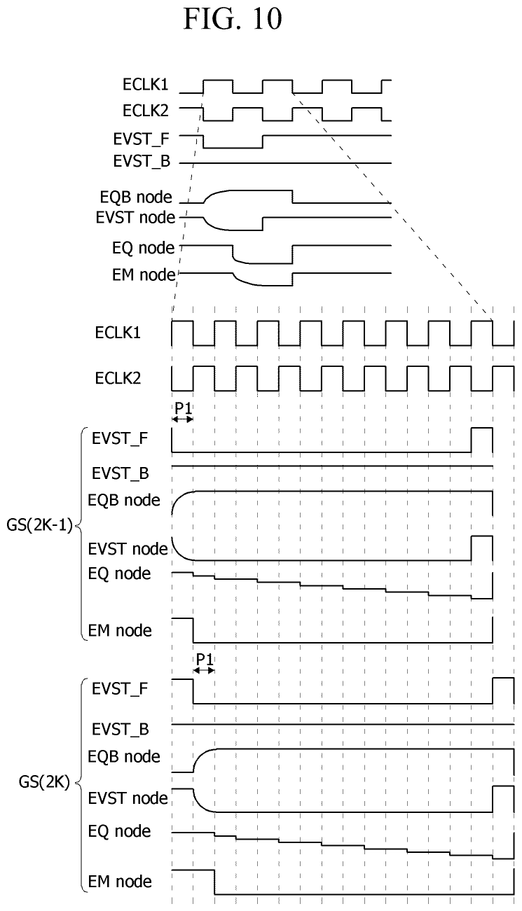

FIG. 9 is a diagram illustrating a light emitting driving circuit included in a gate driver according to an example embodiment of the present disclosure. FIG. 10 is a diagram illustrating a comparison of driving timings between an odd-numbered stage and an even-numbered stage. The same reference numerals are assigned to components that perform substantially the same functions as those in the above-described example embodiment, and redundant descriptions thereof will be omitted.

The plurality of stages according to an example embodiment of the present disclosure can be classified into the odd-numbered stages GS(2K−1) and the even-numbered stages GS(2K), where K is a natural number. The odd-numbered stages GS(2K−1) and the even-numbered stages GS(2K) can be distinguished based on the transistors T1, T5, and Tpclk, to which the first clock signal ECLK1 and the second clock signal ECLK2 are inputted.

Referring to FIG. 9, the light emitting driving circuit serving as the gate driving circuit included in the even-numbered stage GS(2K) can be driven by the high driving voltage EVGH, the low driving voltage EVEL, the forward low voltage EVEL_F, the reverse low voltage EVEL_B, the forward start signal EVST_F, the reverse start signal EVST_B, the first and second clock signals ECLK1 and ECLK2, and the emission control reset signal ERST, and can output the carry signal Carry and the emission signal EM. In the even-numbered stage GS(2K), the first clock signal ECLK1 can be inputted to the second clock node connected to the second electrode of the clock transistor Tpclk, and the second clock signal ECLK2 can be inputted to the first clock node connected to the first transistor T1 and the fifth transistor T5.

The first transistor T1 can be electrically connected between the start signal input node EVST and the Q node EQ. The first transistor T1 can operate in response to a voltage level of the second clock signal ECLK2. The first transistor T1 can be turned on when the second clock signal ECLK2 is at a low level, which is a turn-on level, to connect the start signal input node EVST to the Q node EQ.

The third transistor T3 can be electrically connected between the high driving voltage EVGH input terminal and the Q node EQ. The third transistor T3 can operate in response to a voltage level of the QB node EQB.

The fourth transistor T4 can be electrically connected between the low driving voltage EVEL input terminal and the QB node EQB. The fourth transistor T4 can operate in response to a voltage level of a node between the fifth transistor T5 and the sixth transistor T6.

The fifth transistor T5 and the sixth transistor T6 can be electrically connected between the low driving voltage EVEL input terminal and the high driving voltage EVGH input terminal.

The second clock node can be connected to the gate electrode of the fifth transistor T5. The fifth transistor T5 can operate in response to a voltage level of the second clock signal ECLK2.

The sixth transistor T6 can operate in response to a voltage level of the Q node EQ.

By the operations of the fourth, fifth, and sixth transistors T4, T5, and T6, when the Q node EQ is at a low voltage, a high voltage can be maintained at the QB node EQB, and when the Q node EQ is at a high voltage, a low voltage can be applied to the QB node EQB. When the Q node EQ is at a low voltage, the sixth transistor T6 can be turned on to apply the high driving voltage EVGH to the gate electrode of the fourth transistor T4, thereby turning off the fourth transistor T4 and maintaining the high driving voltage EVGH at the QB node EQB. When the Q node EQ is at a high voltage, the sixth transistor T6 can be turned off, and the fourth transistor T4 can be turned on by the fifth transistor T5 that is turned on. The turned-on fourth transistor T4 can provide the low driving voltage EVEL to the QB node EQB.

The seventh transistor T7 and the eighth transistor T8 can be electrically connected between the high driving voltage EVGH input terminal and the QB node EQB. The seventh transistor T7 can operate in response to a signal supplied to the start signal input node EVST. The eighth transistor T8 can operate in response to a voltage level of the Q node EQ. When the Q node EQ is at a low voltage, the eighth transistor T8 can set and maintain the QB node EQB at the high driving voltage EVGH.

The ninth transistor T9 can be electrically connected between the high driving voltage EVGH input terminal and the Q node EQ. The tenth transistor T10 can be electrically connected between the high driving voltage EVGH input terminal and the output terminal of the emission signal EM. The ninth transistor T9 and the tenth transistor T10 can operate in response to the emission control reset signal ERST.

The pull-up transistor Tup_c and the pull-down transistor Tdn_c for the output of the carry signal Carry can be provided separately from the pull-up transistor Tup and the pull-down transistor Tdn for the output of the emission signal EM. The pull-up transistor Tup_c and the pull-down transistor Tdn_c for the output of the carry signal can operate simultaneously with the pull-up transistor Tup or the pull-down transistor Tdn for the output of the emission signal EM to output the carry signal Carry.

The boot capacitor Cboot can be electrically connected between the Q node EQ and the output terminal of the emission signal EM. The Q node EQ can be coupled to the output terminal of the emission signal EM by the boot capacitor Cboot. At a time point when a turn-on level of the emission signal EM is outputted as a voltage level at the output terminal of the emission signal EM is lowered, a voltage level at the Q node EQ can be lowered by the boot capacitor Cboot.

The pump capacitor Cpump can be electrically connected between the pump transistor Tpump and the clock transistor Tpclk. The pump capacitor Cpump can also be electrically connected between the Q node EQ and the low driving voltage EVEL input terminal. The pump capacitor Cpump can maintain a voltage level of the Q node EQ at a sufficiently low level during a period in which a turn-on level of the emission signal EM is maintained.

The pump transistor Tpump can be electrically connected between the pump capacitor Cpump and the Q node EQ. The gate node of the pump transistor Tpump can be electrically connected to a node between the feed transistor Tfeed and the pump capacitor Cpump. The pump transistor Tpump can operate in response to a signal supplied through the feed transistor Tfeed.

The feed transistor Tfeed can be electrically connected between the gate node of the pump transistor Tpump and the low driving voltage EVEL input terminal. The feed transistor Tfeed can operate in response to a voltage level of the emission signal EM.

The clock transistor Tpclk can be electrically connected between the pump capacitor Cpump and the first clock node. The clock transistor Tpclk can operate in response to a voltage level of the start signal input node EVST to which the forward or reverse start signal EVST_F or EVST_B is inputted.

Referring to FIG. 10, the signals or waveforms of EVST_F, EVST_B, EQB node, EVST node, EQ node, and EM node inputted to the odd-numbered stage GS(2K−1) can lead the signals or waveforms of EVST_F, EVST_B, EQB node, EVST node, EQ node, and EM node inputted to the even-numbered stage GS(2K) by a half period of the clock signals ECLK1 and ECLK2. For example, after a first section P1 of the odd-numbered stage GS(2K−1) proceeds, a first section P1 of the even-numbered stage GS(2K) can proceed. For example, referring FIG. 10, for each of the signals or waveforms of EVST_F, EVST_B, EQB node, EVST node, EQ node, and EM node, after a first section P1 of the odd-numbered stage GS(2K−1) proceeds, a first section P1 of the even-numbered stage GS(2K) can proceed, but not limited thereto.

Referring to FIGS. 7, 9 and 10, in the odd-numbered stage GS(2K−1), the first clock signal ECLK1 can be inputted to the first transistor T1 and the fifth transistor T5, and the second clock signal ECLK2 can be inputted to the clock transistor Tpclk. In the even-numbered stage GS(2K), the second clock signal ECLK2 can be inputted to the first transistor T1 and the fifth transistor T5, and the first clock signal ECLK1 can be inputted to the clock transistor Tpclk.

In the odd-numbered stage GS(2K-1), the first clock signal ECLK1 can be inputted to the first transistor T1. Referring to the first section P1 in the odd-numbered stage GS(2K-1), the first clock signal ECLK1 input to the first transistor T1 can start at a high voltage level.

In the even-numbered stage GS(2K), the second clock signal ECLK2 can be inputted to the first transistor T1. Referring to the first interval T1 in the even-numbered stage GS(2K), the second clock signal ECLK2 input to the first transistor T1 can start at a high voltage level.

In the display device according to an example embodiment of the present disclosure, the gate driving circuits positioned between the sub-pixel circuits can be classified into the odd-numbered stage GS(2K−1) and the even-numbered stage GS(2K), as described above. These can be distinguished based on the types of the clock signals ECLK1 and ECLK2 input to the first transistor T1, the fifth transistor T5, and the clock transistor Tpclk.

In the arrangement of such gate driving circuits, the clock signals input to the respective transistors T1, T5, and Tpclk can be alternately switched. If the same transistor arrangement order is applied to all lines during the implementation of these circuits in the display panel, an inefficiency can occur, in which the wire length becomes excessively long and the effective design area is reduced.

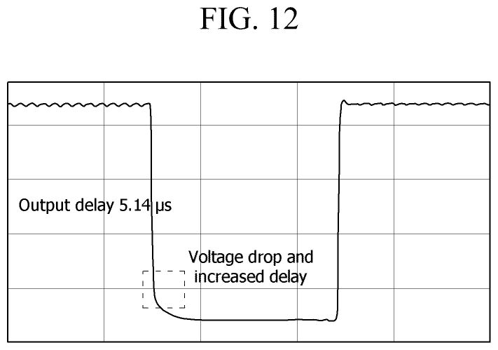

FIG. 11 is a schematic plan view illustrating an arrangement structure of a display device. FIG. 12 is a graph illustrating unstable signal output due to an increase in a wire length.

Referring to FIG. 11, the display panel PN according to an example embodiment of the present disclosure includes a pad region PA including a plurality of gate pads GP11, GP12, GP21, GP22, and GP3, and the display area AA. The pad region PA can be positioned in a line on glass (LOG) area of the display panel PN. The LOG area is the non-display area outside the display area AA in the display panel PN. A film, e.g., a COF, on which the source driver IC SDIC is mounted, can be bonded to the pad region PA of the display panel PN using an anisotropic conductive film (ACF), and can be electrically connected to the pads of the pad region. The film having the source driver IC mounted thereon can transmit data signals or gate signals to a plurality of pads DP, VRP, GP11, GP12, GP21, GP22, and GP3 arranged in the pad region PA.

The pad region PA can be positioned between the display panel PN and the source driver IC and can supply data signals and gate signals, which are transmitted from the source driver IC, to the sub-pixel circuits A/A and the gate driving circuits positioned in the display panel PN.

The plurality of sub-pixel circuits and the gate driving circuits can be arranged in the display panel PN. The gate driving circuit can include a plurality of transistors. The gate driving circuit can include the first transistor, the fifth transistor, and the clock transistor described in the drawing above.

In one example embodiment, the light emitting element positioned in the display device 100 according to an example embodiment of the present disclosure can be a light emitting diode (LED) or a micro light emitting diode (micro LED). When the light emitting element is implemented as a micro LED, a size of the light emitting element can be 100 μm or less. In the case where such a very small light emitting element is used, if one stage including the entire gate driving circuit is positioned between the sub-pixel circuits A/A or between the pixel circuits including the sub-pixel circuits A/A, a distance between the sub-pixels can become greater than a distance between the sub-pixels required for a desired resolution.

The gate driving circuit positioned in the display panel PN according to an example embodiment of the present disclosure can include a plurality of transistors. The plurality of transistors can include any one transistor (e.g., transistor A (TA), transistor B (TB), transistor C (TC), transistor D (TD), or the like) in the gate driving circuit described above. The transistors TA, TB, TC, and TD of the gate driving circuit included in any one stage can be arranged along the first direction (e.g., the X-axis direction).

In consideration of the size of the sub-pixel circuit A/A that includes a very small light emitting element, the sub-pixel circuit A/A can be positioned between the plurality of transistors. For example, any one sub-pixel circuit A/A can be positioned between the transistor A (TA) and the transistor B (TB), and any one sub-pixel circuit A/A can be positioned between the transistor D (TD) and the transistor C (TC).

The display panel PN can include a plurality of pixel lines. The plurality of pixel lines can include a (2K−1)^{th} pixel line PXL(2K−1) and a (2K)^{th} pixel line PXL(2K), where K is a natural number. Each of them can include the plurality of sub-pixel circuits A/A. The plurality of sub-pixel circuits A/A located in each of the plurality of pixel lines can be arranged in the first direction (e.g., the X-axis direction).

The sub-pixel circuits arranged in the odd-numbered pixel line (e.g., the (2K−1)^{th} pixel line PXL(2K−1)) can simultaneously receive a signal outputted from the gate driving circuit positioned in the same stage (e.g., the (2K−1)^{th} stage GS(2K−1)). The (2K−1)^{th} stage GS(2K−1) can be implemented as the gate driving circuit described in the above example embodiment.

The sub-pixel circuits arranged in the even-numbered pixel line (e.g., the (2K)^{th} pixel line PXL(2K)) can simultaneously receive a signal output from the gate driving circuit positioned in the same stage (e.g., the (2K)^{th} stage GS(2K)). The (2K)^{th} stage GS(2K) can be implemented as the gate driving circuit described in the above example embodiment.

Each of the (2K)^{th} stage GS(2K) and the (2K−1)^{th} stage GS(2K−1) can include the transistor A (TA), the transistor B (TB), the transistor C (TC), and the transistor D (TD). In order for the sub-pixel circuit A/A to emit light properly, the output of the gate driving circuit that provides a gate signal must be normally performed.

As described above, in the odd-numbered stage GS(2K−1), the first clock signal ECLK1 can be inputted to the first transistor T1 and the fifth transistor T5, and the second clock signal ECLK2 can be inputted to the clock transistor Tpclk. In the even-numbered stage GS(2K), the second clock signal ECLK2 can be inputted to the first transistor T1 and the fifth transistor T5, and the first clock signal ECLK1 can be inputted to the clock transistor Tpclk. In this manner, the input positions of the clock signals ECLK1 and ECLK2 in the odd-numbered stages GS(2K−1) and the even-numbered stages GS(2K) can be alternately switched.

The pad region PA can include the plurality of pads DP, VRP, GP11, GP12, GP21, GP22, and GP3. The plurality of pads DP, VRP, GP11, GP12, GP21, GP22, and GP3 can include the gate pads GP11, GP12, GP21, GP22, and GP3, the plurality of data pads DP, and the like. The pad region PA can further include a reference voltage pad VRP that supplies a reference voltage. The reference voltage can be supplied to the sub-pixel circuit.

The plurality of gate pads GP11, GP12, GP21, GP22, and GP3 can include first gate pads GP11 and GP12, second gate pads GP21 and GP22, and a third gate pad GP3. They can serve to transmit gate signals to the gate driving circuit.

For example, the first gate pads GP11 and GP12 can supply the aforementioned first clock signal. For example, the second gate pads GP21 and GP22 can supply the aforementioned second clock signal. For example, the third gate pad GP3 can supply the emission control reset signal.

A plurality of dummy pads and the plurality of data pads DP can be positioned between the plurality of gate pads GP11, GP12, GP21, GP22, and GP3.

The plurality of data pads DP can be positioned between the plurality of gate pads GP11, GP12, GP21, GP22, and GP3. In consideration of a feature of the display device according to an example embodiment, in which the sub-pixel circuit A/A is positioned between the plurality of transistors included in the gate driving circuit due to the small size of the light emitting element, the data pads DP can be positioned between the plurality of gate pads GP11, GP12, GP21, GP22, and GP3. For example, the data pads DP and the gate pads GP11, GP12, GP21, GP22, and GP3 can be alternately arranged. However, the arrangement is not limited thereto, and the reference voltage pad VRP that supplies the reference voltage to the sub-pixel circuit can be positioned between the plurality of data pads DP.

Both the odd-numbered stage GS(2K−1) and the even-numbered stage GS(2K) can include the transistor A (TA), the transistor B (TB), the transistor D (TD), and the transistor C (TC), which are sequentially arranged in the first direction.

In one example embodiment, the first gate pads GP11 and GP12 and the second gate pads GP21 and GP22 can supply the first clock signal and the second clock signal, respectively. In this case, the transistor A (TA) can be the first transistor T1 in FIGS. 7 and 9. The transistor B (TB) can be the fifth transistor T5 in FIGS. 7 and 9. The transistor C (TC) can be the clock transistor Tpclk. The transistor D (TD) can be one or more of the transistors, other than the transistor A (TA), the transistor B (TB), and the transistor C (TC), in FIGS. 7 and 9.

In the pad region, the gate pads GP11, GP12, GP21, and GP22 can be arranged in accordance with the arrangement order of the transistor A (TA), the transistor B (TB), the transistor D (TD), and the transistor C (TC) of the odd-numbered stage GS(2K−1), but are not limited thereto. The gate pads GP11, GP12, GP21, and GP22 are connected to second-direction wires formed in parallel along the second direction (the Y direction). For example, the first gate pads GP11 and GP12 can include a first-first gate pad GP11 connected to a first clock signal wire GPL11 and a first-second gate pad GP12 connected to a second clock signal wire GPL12. Through the first gate pads GP11 and GP12, the first clock signal ECLK1 can be applied to the first and second clock signal wires GPL11 and GPL12. The second gate pads GP21 and GP22 can include a second-first gate pad GP21 connected to a third clock signal wire GPL21 and a second-second gate pad GP22 connected to a fourth clock signal wire GPL22. Through the second gate pads GP21 and GP22, the second clock signal ECLK2 can be applied to the third and fourth clock signal wires GPL21 and GPL22.

The first clock signal wire GPL11 can be connected to the transistors A (TA) of odd-numbered stages GS(2K−1) and GS(2K+1). The second clock signal wire GPL12 can be connected to the transistors B (TB) of the odd-numbered stages GS(2K−1) and GS(2K+1), and to the transistors C (TC) of even-numbered stages GS(2K) and GS(2K+2).

The third clock signal wire GPL21 can be connected to the transistors A (TA) of the even-numbered stages GS(2K) and GS(2K+2). The fourth clock signal wire GPL22 can be connected to the transistors C (TC) of the odd-numbered stages GS(2K−1) and GS(2K+1), and to the transistors B (TB) of the even-numbered stages GS(2K) and GS(2K+2).

When the first gate pads GP11 and GP12 and the second gate pads GP21 and GP22 are sequentially arranged in accordance with the arrangement order of the transistor A (TA), the transistor B (TB), and the transistor C (TC) included in the odd-numbered stage GS(2K−1), the length of the clock signal wire (e.g., the second clock signal wire GPL12, the third clock signal wire GPL21, or the fourth clock signal wire GPL22) in the even-numbered stage GS(2K) can increase due to the clock signal being inputted in the opposite manner, and parasitic capacitance can increase due to the large number of overlapping portions between the wires, thereby causing RC delay. This can cause deviations in the emission signals between the pixel lines and in the luminance of the pixels.

As the length of the clock signal wire increases in this manner, the effective design area at the place where the wire passes can be reduced, and unnecessary parasitic capacitance can occur due to overlapping with other wires. In addition, due to an increase in wire resistance caused by the increased wire length, an accurate clock signal can fail to be inputted, which can result in abnormal output of the gate driving circuit and a reduction in the reliability of the display device.

Referring to FIG. 12, as shown in the simulation graph, a delay can increase and the waveform can lie down due to a voltage drop phenomenon.

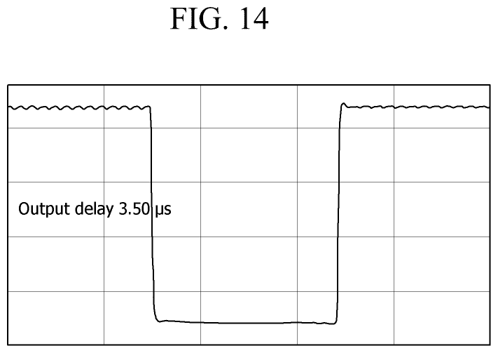

FIG. 13 is a schematic plan view illustrating an arrangement structure of a display device according to an example embodiment of the present disclosure. In FIG. 13, redundant descriptions of the example embodiment illustrated in FIG. 11 are omitted. FIG. 14 is a graph illustrating stable signal output resulting from the adjustment of wire length. The same reference numerals are assigned to components that perform substantially the same functions as those in the drawings described above, and redundant descriptions thereof will be omitted.

Referring to FIG. 13, the first clock signal wire GPL11 can be connected to the transistors A (TA) of the odd-numbered stages GS(2K−1) and GS(2K+1), and to the transistors C (TC) of the even-numbered stages GS(2K) and GS(2K+2). The second clock signal wire GPL12 can be connected to the transistors B (TB) of the odd-numbered stages GS(2K−1) and GS(2K+1).

The third clock signal wire GPL21 can be connected to the transistors B (TB) of the even-numbered stages GS(2K) and GS(2K+2). The fourth clock signal wire GPL22 can be connected to the transistors C (TC) of the odd-numbered stages GS(2K−1) and GS(2K+1), and to the transistors A (TA) of the even-numbered stages GS(2K) and GS(2K+2).

The lengths and resistances of the clock signal wires GPL11 to GPL22, which are positioned in parallel along the second direction (Y direction) in the display area AA, are equal to each other.

In the odd-numbered stages, e.g., in the (2K−1)^{th} and (2K+1)^{th} stages GS(2K−1) and GS(2K+1), according to one example embodiment, the transistor A (TA), the transistor B (TB), and the transistor C (TC) can be arranged from left to right in the first direction (the X direction). In the even-numbered stages, e.g., in the (2K)^{th} and (2K+2)^{th} stages GS(2K) and GS(2K+2), the transistor C (TC), the transistor B (TB), and the transistor A (TA) can be arranged from left to right in the first direction (the X direction).

When viewed in the second direction (the Y direction) of the display panel PN, the transistor A (TA) of the odd-numbered stage, e.g., the (2K−1)^{th} stage GS(2K−1), can be positioned adjacent to the transistor C (TC) of the even-numbered stage, e.g., the (2K)^{th} stage GS(2K). When viewed in the second direction (Y direction) of the display panel PN, the transistor B (TB) of the (2K−1)^{th} stage GS(2K−1) can be positioned adjacent to the transistor B (TB) of the (2K+1)^{th} stage GS(2K+1), with the transistor D (TD) of the (2K)^{th} stage GS(2K) interposed therebetween.

When viewed in the second direction (the Y direction) of the display panel PN, the transistors C (TC) of the odd-numbered stages, e.g., the (2K−1)^{th} and (2K+1)^{th} stages GS(2K−1) and GS(2K+1), can be positioned adjacent to the transistors A (TA) of the even-numbered stages, e.g., the (2K)^{th} and (2K+2)^{th} stages GS(2K) and GS(2K+2). When viewed in the second direction (Y direction) of the display panel PN, the transistor D (TD) of the (2K−1)^{th} stage GS(2K−1) can be positioned adjacent to the transistor D (TD) of the (2K+1)^{th} stage GS(2K+1), with the transistor B (TB) of the (2K)^{th} stage GS(2K) interposed therebetween.

The length of the first clock signal wire GPL11 extending from the first-first gate pad GP11 to the transistor A (TA) of the odd-numbered stage GS(2K−1) can be equal to the length of the fourth clock signal wire GPL22 extending from the second-second gate pad GP22 to the transistor C (TC) of the odd-numbered stage GS(2K−1).

The length of the first clock signal wire GPL11 extending from the first-first gate pad GP11 to the transistor C (TC) of the even-numbered stage GS(2K) can be equal to the length of the third clock signal wire GPL21 extending from the second-first gate pad GP21 to the transistor B (TB) of the even-numbered stage GS(2K).

The length of the first clock signal wire GPL11 extending from the first-first gate pad GP11 to the transistor C (TC) of the even-numbered stage GS(2K) can be equal to the length of the fourth clock signal wire GPL22 extending from the second-second gate pad GP22-2 to the transistor A (TA) of the even-numbered stage GS(2K).

In the odd numbered stages GS(2K-1) and GS(2K+1) according to one example embodiment, the transistors can be arranged in the order of the transistor A (TA), the transistor B (TB), the transistor D (TD), and the transistor C (TC) along the first direction X. In the even numbered stages GS(2K) and GS(2K+2), the transistors can be arranged in the order of the transistor C (TC), the transistor D (TD), the transistor B (TB), and the transistor A (TA) along the first direction X.

In the process of symmetrically and interchangeably arranging the transistor A (TA) and the transistor B (TB) with respect to the transistor C (TC), the transistor D (TD) can be selected as a transistor required to balance the two arrangements. For example, in the odd-numbered stages GS(2K−1) and GS(2K+1) according to one example embodiment, the transistor B (TB) can be positioned to the right of the transistor A (TA) in the first direction (X direction), and in the even-numbered stages GS(2K) and GS(2K+2), the transistor A (TA) can be positioned to the right of the transistor B (TB). In this case, in order to balance the transistor arrangement between the odd-numbered stages GS(2K−1) and GS(2K+1) and the even-numbered stages GS(2K) and GS(2K+2), the transistor D (TD) of the odd-numbered stages GS(2K−1) and GS(2K+1) can be positioned between the transistor B (TB) and the transistor C (TC) in the first direction. The transistor D (TD) of the even-numbered stages GS(2K) and GS(2K+2) can be positioned between the transistor C (TC) and the transistor B (TB) in the first direction.

In the above-described example embodiment, the arrangement order of the transistors TA, TB, TC, and TD included in the odd-numbered stages and the even-numbered stages can be reversed with respect to each other.

According to one example embodiment, balance in the design structure can be achieved, so that the wire length can be reduced and overlapping portions between the wires can be decreased, thereby improving the output characteristics of the gate driving circuit. Accordingly, the reliability of the gate driving circuit in the display device can be enhanced, low-power driving can be enabled, and RC delay of the gate signal such as the emission signal can be reduced, thereby reducing deviations in the emission signals between pixel lines and in luminance of the pixels. In addition, since wires that had been extended in the first direction to interconnect the wires and the transistors on the display panel are no longer required, the number of wires in the first direction can be reduced in the display panel PN, and as a result, the effective design area for the gate driving circuit and the pixels of the display panel can be increased.

Referring to FIG. 14, as shown in the simulation graph, it is confirmed that a voltage drop phenomenon is reduced and the waveform stands correctly.

According to one or more example embodiments of the present disclosure, the display apparatus can be applied to mobile apparatuses, video phones, smart watches, watch phones, wearable apparatus, foldable apparatus, rollable apparatus, bendable apparatus, flexible apparatus, curved apparatus, sliding apparatus, variable apparatus, electronic organizer, electronic books, portable multimedia players (PMPs), personal digital assistants (PDAs), MP3 players, mobile medical apparatuses, desktop PCs, laptop PCs, netbook computers, workstations, navigations, vehicle navigations, vehicle display apparatuses, vehicle apparatuses, theater apparatuses, theater display apparatuses, televisions, wallpaper apparatuses, signage apparatuses, game apparatuses, laptops, monitors, cameras, camcorders, and home appliances, etc. Additionally, the display apparatus according to one or more example embodiments of the present disclosure can be applied to organic light emitting lighting apparatuses or inorganic light emitting lighting apparatuses.

The objects to be achieved by the present disclosure, the means for achieving the objects, and effects of the present disclosure described above do not specify essential features of the claims, and thus, the scope of the claims is not limited to the disclosure of the present disclosure.

Although the example embodiments of the present disclosure have been described in more detail with reference to the accompanying drawings, the present disclosure is not limited thereto and can be embodied in many different forms without departing from the technical concept of the present disclosure. Therefore, the example embodiments disclosed in the present disclosure are provided for illustrative purposes only and are not intended to limit the technical concept of the present disclosure. The scope of the technical concept of the present disclosure is not limited thereto. Therefore, it should be understood that the above-described example embodiments are illustrative in all aspects and do not limit the present disclosure.

What is claimed is:

1. A display panel comprising:
sub-pixel circuits;
a gate driving circuit including transistors positioned between the sub-pixel circuits;
first-direction wires positioned in parallel along a first direction; and
second-direction wires positioned in parallel along a second direction intersecting the first direction,
wherein the gate driving circuit includes:
a plurality of odd-numbered stages; and
a plurality of even-numbered stages,
wherein each of the odd-numbered stages and the even-numbered stages includes a transistor A, a transistor B, and a transistor C, and
wherein the transistor A, the transistor B, and the transistor C of the odd-numbered stages are arranged in an order from one side to another side in the first direction, and
wherein the transistor C, the transistor B, and the transistor A of the even-numbered stages are arranged in an order from the one side to the another side in the first direction.

2. The display panel of claim 1, wherein a first clock signal is applied to the transistor A and the transistor B of the odd-numbered stages,
a second clock signal is applied to the transistor C of the odd-numbered stages,
the second clock signal is applied to the transistor A and the transistor B of the even-numbered stages, and
the first clock signal is applied to the transistor C of the even-numbered stages.

3. The display panel of claim 1, wherein the second-direction wires include:
a first clock signal wire connected to the transistor A of the odd-numbered stages and to the transistor C of the even-numbered stages;
a second clock signal wire connected to the transistor B of the odd-numbered stages;
a third clock signal wire connected to the transistor B of the even-numbered stages; and
a fourth clock signal wire connected to the transistor C of the odd-numbered stages and to the transistor A of the even-numbered stages.

4. The display panel of claim 3, wherein lengths of the first clock signal wire, the second clock signal wire, the third clock signal wire, and the fourth clock signal wire are equal to each other.

5. The display panel of claim 1, wherein each of the odd-numbered stages further includes a transistor D positioned between the transistor B and the transistor C of the odd-numbered stage in the first direction, and
each of the even-numbered stages further includes a transistor D positioned between the transistor B and the transistor C of the even-numbered stage in the first direction.

6. The display panel of claim 5, wherein, when viewed in the second direction, the transistor A of the odd-numbered stages is positioned adjacent to the transistor C of the even-numbered stages,
when viewed in the second direction, the transistor B of a (2K−1)^{th} stage is positioned adjacent to the transistor B of a (2K+1)^{th} stage, with the transistor D of a (2K)^{th} stage interposed therebetween, where K is a natural number,
when viewed in the second direction, the transistor C of the odd-numbered stages is positioned adjacent to the transistor A of the even-numbered stages, and
when viewed in the second direction, the transistor D of the (2K−1)^{th} stage is positioned adjacent to the transistor D of the (2K+1)^{th} stage, with the transistor B of the (2K)^{th} stage interposed therebetween.

7. The display panel of claim 2, wherein the transistor A of the odd-numbered stages includes a first electrode connected to a Q node of a corresponding odd-numbered transistor, a gate electrode to which the first clock signal is applied, and a second electrode connected to a start signal input node, and
wherein the transistor A of the even-numbered stages includes a first electrode connected to a Q node of a corresponding even-numbered transistor, a gate electrode to which the second clock signal is applied, and a second electrode connected to a start signal input node.

8. The display panel of claim 7, wherein the transistor B of the odd-numbered stages includes a first electrode, a gate electrode to which the first clock signal is applied, and a second electrode, and
wherein the transistor B of the even-numbered stages includes a first electrode, a gate electrode to which the second clock signal is applied, and a second electrode.

9. The display panel of claim 8, wherein the transistor C of the odd-numbered stages includes a first electrode, a gate electrode connected to a start signal input node, and a second electrode to which the second clock signal is applied, and
wherein the transistor C of the even-numbered stages includes a first electrode, a gate electrode connected to a start signal input node, and a second electrode to which the first clock signal is applied.

10. The display panel of claim 1, wherein the gate driving circuit includes a light emitting driving circuit configured to supply an emission signal to the sub-pixel circuits.

11. A display device comprising:
a display panel including sub-pixel circuits, a gate driving circuit including transistors positioned between the sub-pixel circuits, first-direction wires positioned in parallel along a first direction, and second-direction wires positioned in parallel along a second direction intersecting the first direction; and
a source circuit electrically connected to a pad region of the display panel and configured to supply a data signal and at least one clock signal to the display panel,
wherein the gate driving circuit includes:
a plurality of odd-numbered stages, and
a plurality of even-numbered stages,
wherein each of the odd-numbered stages and the even-numbered stages includes a transistor A, a transistor B, and a transistor C,
wherein the transistor A, the transistor B, and the transistor C of the odd-numbered stages are arranged in an order from one side to another side in the first direction, and
wherein the transistor C, the transistor B, and the transistor A of the even-numbered stages are arranged in an order from one side to the another side in the first direction.

12. The display device of claim 11, wherein the at least one clock signal includes a first clock signal and a second clock signal,
the first clock signal is applied to the transistor A and the transistor B of the odd-numbered stages,
the second clock signal is applied to the transistor C of the odd-numbered stages,
the second clock signal is applied to the transistor A and the transistor B of the even-numbered stages, and
the first clock signal is applied to the transistor C of the even-numbered stages.

13. The display device of claim 11, wherein the second-direction wires include:
a first clock signal wire connected to the transistor A of the odd-numbered stages and to the transistor C of the even-numbered stages;
a second clock signal wire connected to the transistor B of the odd-numbered stages;
a third clock signal wire connected to the transistor B of the even-numbered stages; and
a fourth clock signal wire connected to the transistor C of the odd-numbered stages and to the transistor A of the even-numbered stages.

14. The display device of claim 13, wherein lengths of the first clock signal wire, the second clock signal wire, the third clock signal wire, and the fourth clock signal wire are equal to each other.

15. The display device of claim 11, wherein each of the odd-numbered stages further includes a transistor D positioned between the transistor B and the transistor C of the odd-numbered stage in the first direction, and
each of the even-numbered stages further includes a transistor D positioned between the transistor B and the transistor C of the even-numbered stage in the first direction.

16. The display device of claim 15, wherein, when viewed in the second direction, the transistor A of the odd-numbered stages is positioned adjacent to the transistor C of the even-numbered stages,
when viewed in the second direction, the transistor B of a (2K−1)^{th} stage is positioned adjacent to the transistor B of a (2K+1)^{th} stage, with the transistor D of a (2K)^{th} stage interposed therebetween, where K is a natural number,
when viewed in the second direction, the transistor C of the odd-numbered stages is positioned adjacent to the transistor A of the even-numbered stages, and
when viewed in the second direction, the transistor D of the (2K−1)^{th} stage is positioned adjacent to the transistor D of the (2K+1)^{th} stage, with the transistor B of the (2K)^{th} stage interposed therebetween.

17. The display device of claim 12, wherein the transistor A of the odd-numbered stages includes a first electrode connected to a Q node of a corresponding odd-numbered transistor, a gate electrode to which the first clock signal is applied, and a second electrode connected to a start signal input node,
the transistor A of the even-numbered stages includes a first electrode connected to a Q node of a corresponding even-numbered transistor, a gate electrode to which the second clock signal is applied, and a second electrode connected to a start signal input node,
the transistor B of the odd-numbered stages includes a first electrode, a gate electrode to which the first clock signal is applied, and a second electrode,
the transistor B of the even-numbered stages includes a first electrode, a gate electrode to which the second clock signal is applied, and a second electrode,
the transistor C of the odd-numbered stages includes a first electrode, a gate electrode connected to a start signal input node, and a second electrode to which the second clock signal is applied, and
the transistor C of the even-numbered stages includes a first electrode, a gate electrode connected to a start signal input node, and a second electrode to which the first clock signal is applied.

18. The display device of claim 11, wherein the gate driving circuit includes a light emitting driving circuit configured to supply an emission signal to the sub-pixel circuits.

19. A gate driving circuit comprising:
a plurality of odd-numbered stages; and
a plurality of even-numbered stages,
wherein each of the odd-numbered stages and the even-numbered stages includes a transistor A, a transistor B, and a transistor C, and
wherein the transistor A, the transistor B, and the transistor C of the odd-numbered stages are arranged in an order from one side to another side in a first direction, and
wherein the transistor C, the transistor B, and the transistor A of the even-numbered stages are arranged in an order from the one side to the another side in the first direction.

20. The gate driving circuit of claim 19, wherein a first clock signal is applied to the transistor A and the transistor B of the odd-numbered stages,
a second clock signal is applied to the transistor C of the odd-numbered stages,
the second clock signal is applied to the transistor A and the transistor B of the even-numbered stages, and
the first clock signal is applied to the transistor C of the even-numbered stages,
wherein a first clock signal wire is connected to the transistor A of the odd-numbered stages and to the transistor C of the even-numbered stages,
a second clock signal wire is connected to the transistor B of the odd-numbered stages,
a third clock signal wire is connected to the transistor B of the even-numbered stages, and
a fourth clock signal wire is connected to the transistor C of the odd-numbered stages and to the transistor A of the even-numbered stages,
wherein lengths of the first clock signal wire, the second clock signal wire, the third clock signal wire, and the fourth clock signal wire are equal to each other.
